(19) United States
(12) Patent Application Publication
(10) Pub. No.: US 2026/0313532 A1
(43) Pub. Date: Oct. 8, 2026

(54) ANTENNA SUBSET SELECTION FOR MULTI-TRANSMISSION AND RECEPTION POINT UPLINK TRANSMISSIONS

(71) Applicant: QUALCOMM Incorporated, San Diego, CA (US)

(72) Inventors: Narayan PRASAD, Westfield, NJ (US); Mostafa KHOSHNEVISAN, San Diego, CA (US); Tao LUO, San Diego, CA (US); Junyi LI, Greentown, PA (US)

(21) Appl. No.: 19/630,332

(22) Filed: Mar. 26, 2026

Related U.S. Application Data
(60) Provisional application No. 63/783,100, filed on Apr. 3, 2025.

(51) Int. Cl. H04W 48/20; H04W 24/08; H04W 24/10

(52) U.S. Cl. CPC H04W 48/20; H04W 24/08; H04W 24/10

(57) ABSTRACT

This disclosure provides methods, components, devices and systems for antenna subset selection for multi-transmission and reception point (TRP) uplink transmissions. For example, a user equipment (UE) may receive one or more control messages that indicate a set of channel state information (CSI) report configurations. Each CSI report configuration of the set may include one or more sub-configurations of a set of sub-configurations and may be associated with a respective TRP of a set of TRPs. The UE may receive an indication to perform an evaluation of measurements associated with one or more downlink reference signals. The UE may perform the evaluation of measurements in accordance with one or more combinations (e.g., tuples) of the set of sub-configurations. Accordingly, the UE may select one or more antenna ports for communication with the set of TRPs in accordance with the evaluation of the measurements.

### CROSS REFERENCES

The present application for patent claims priority to U.S. Provisional Patent Application No. 63/783,100 by PRASAD et al., entitled “ANTENNA SUBSET SELECTION FOR MULTI-TRANSMISSION AND RECEPTION POINT UPLINK TRANSMISSIONS” and filed Apr. 3, 2025, which is assigned to the assignee hereof and is expressly incorporated by reference in its entirety herein.

### INTRODUCTION

The following relates generally to wireless communication, and more specifically to systems, devices, methods, and techniques associated with managing selection of antenna subsets for communication with one or more TRPs.

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication by a UE is described. The method may include receiving one or more control messages that indicate a set of multiple CSI report configurations, where each CSI report configuration includes one or more sub-configurations, and where each CSI report configuration of the set of multiple CSI report configurations is associated with a respective transmission and reception point (TRP) of a set of multiple TRPs, receiving an indication to perform an evaluation of one or more measurements associated with one or more downlink reference signals in accordance with one or more combinations of sub-configurations, where each combination of the one or more combinations includes a set of multiple sub-configurations, and where each sub-configuration of the set of multiple sub-configurations is from a respective CSI report configuration, and communicating with the set of multiple TRPs via one or more antenna ports selected by the UE, the one or more antenna ports selected in accordance with the evaluation of the one or more measurements.

A UE for wireless communication is described. The UE may include a processing system that includes processor circuitry and memory circuitry that stores code. The processing system may be configured to cause the UE to receive one or more control messages that indicate a set of multiple CSI report configurations, where each CSI report configuration includes one or more sub-configurations, and where each CSI report configuration of the set of multiple CSI report configurations is associated with a respective TRP of a set of multiple TRPs, receive an indication to perform an evaluation of one or more measurements associated with one or more downlink reference signals in accordance with one or more combinations of sub-configurations, where each combination of the one or more combinations includes a set of multiple sub-configurations, and where each sub-configuration of the set of multiple sub-configurations is from a respective CSI report configuration, and communicate with the set of multiple TRPs via one or more antenna ports selected by the UE, the one or more antenna ports selected in accordance with the evaluation of the one or more measurements.

Another UE for wireless communication is described. The UE may include one or more memories and one or more processors coupled with the one or more memories. The one or more processors may be configured to cause the UE to receive one or more control messages that indicate a set of multiple CSI report configurations, where each CSI report configuration includes one or more sub-configurations, and where each CSI report configuration of the set of multiple CSI report configurations is associated with a respective TRP of a set of multiple TRPs, receive an indication to perform an evaluation of one or more measurements associated with one or more downlink reference signals in accordance with one or more combinations of sub-configurations, where each combination of the one or more combinations includes a set of multiple sub-configurations, and where each sub-configuration of the set of multiple sub-configurations is from a respective CSI report configuration, and communicate with the set of multiple TRPs via one or more antenna ports selected by the UE, the one or more antenna ports selected in accordance with the evaluation of the one or more measurements.

Another UE for wireless communication is described. The UE may include means for receiving one or more control messages that indicate a set of multiple CSI report configurations, where each CSI report configuration includes one or more sub-configurations, and where each CSI report configuration of the set of multiple CSI report configurations is associated with a respective TRP of a set of multiple TRPs, means for receiving an indication to perform an evaluation of one or more measurements associated with one or more downlink reference signals in accordance with one or more combinations of sub-configurations, where each combination of the one or more combinations includes a set of multiple sub-configurations, and where each sub-configuration of the set of multiple sub-configurations is from a respective CSI report configuration, and means for communicating with the set of multiple TRPs via one or more antenna ports selected by the UE, the one or more antenna ports selected in accordance with the evaluation of the one or more measurements.

A non-transitory computer-readable medium storing code for wireless communication is described. The code may include instructions executable by one or more processors to receive one or more control messages that indicate a set of multiple CSI report configurations, where each CSI report configuration includes one or more sub-configurations, and where each CSI report configuration of the set of multiple CSI report configurations is associated with a respective TRP of a set of multiple TRPs, receive an indication to perform an evaluation of one or more measurements associated with one or more downlink reference signals in accordance with one or more combinations of sub-configurations, where each combination of the one or more combinations includes a set of multiple sub-configurations, and where each sub-configuration of the set of multiple sub-configurations is from a respective CSI report configuration, and communicate with the set of multiple TRPs via one or more antenna ports selected by the UE, the one or more antenna ports selected in accordance with the evaluation of the one or more measurements.

Some examples of the method, UEs, and non-transitory computer-readable medium described herein may further include operations, features, means, or instructions for transmitting a report that indicates the one or more antenna ports selected by the UE.

Some examples of the method, UEs, and non-transitory computer-readable medium described herein may further include operations, features, means, or instructions for receiving, in response to the report, an acknowledgment message that indicates a selected combination of the one or more combinations of sub-configurations.

In some examples of the method, UEs, and non-transitory computer-readable medium described herein, transmitting the report may include operations, features, means, or instructions for transmitting the report via one or more uplink control information messages, via one or more medium access control-control element messages, via one or more messages triggered by one or more events, or any combination thereof.

Some examples of the method, UEs, and non-transitory computer-readable medium described herein may further include operations, features, means, or instructions for receiving a metric type indication that indicates a communication scheme usable for communications with the set of multiple TRPs, the communication scheme including a joint reception scheme, a spatial division multiplexing (SDM) scheme, a single frequency network (SFN) scheme, a time division multiplexing (TDM) scheme, or any combination thereof, where the one or more antenna ports may be selected in accordance with the communication scheme.

Some examples of the method, UEs, and non-transitory computer-readable medium described herein may further include operations, features, means, or instructions for receiving a metric type indication that indicates an energy efficiency scheme usable for communications with the plurality of TRPs, where the energy efficiency scheme indicates one or more energy efficiency metrics, and where the one or more antenna ports are selected in accordance with the energy efficiency scheme.

Some examples of the method, UEs, and non-transitory computer-readable medium described herein may further include operations, features, means, or instructions for receiving, for each TRP of the set of multiple TRPs, an indication of one or more parameters associated with computation of an uplink spectral efficiency associated with each TRP of the set of multiple TRPs, where the evaluation may be based on the one or more parameters for each TRP.

In some examples of the method, UEs, and non-transitory computer-readable medium described herein, the one or more parameters include a quantization distortion indication, a covariance matrix for uplink noise and interference associated with a respective TRP, one or more calibration parameters, or any combination thereof.

Some examples of the method, UEs, and non-transitory computer-readable medium described herein may further include operations, features, means, or instructions for transmitting a message including a first indication of a quantity of ports selected for each combination of the one or more combinations, a second indication of one or more metric values associated with the one or more downlink reference signals in accordance with the evaluation of the one or more measurements, a third indication of a respective metric value associated with each combination of the one or more combinations, or any combination thereof.

In some examples of the method, UEs, and non-transitory computer-readable medium described herein, the message further includes a fourth indication of a quantity of ports selected for each combination of a threshold quantity of combinations and a respective metric value associated with each combination of the threshold quantity of combinations.

Some examples of the method, UEs, and non-transitory computer-readable medium described herein may further include operations, features, means, or instructions for receiving a size indication that indicates a respective quantity of sub-configurations within each combination of the one or more combinations.

In some examples of the method, UEs, and non-transitory computer-readable medium described herein, communicating with the set of multiple TRPs may include operations, features, means, or instructions for communicating with each TRP of the set of multiple TRPs via a respective set of one or more antenna ports of a set of multiple antenna ports, each respective set of one or more antenna ports selected by the UE in accordance with the evaluation of the one or more measurements.

In some examples of the method, UEs, and non-transitory computer-readable medium described herein, each CSI report configuration of the set of multiple CSI report configurations may be associated with a CSI resource configuration that indicates multiple downlink reference signal resources associated with each respective TRP of the set of multiple TRPs.

In some examples of the method, UEs, and non-transitory computer-readable medium described herein, the one or more antenna ports may be selected based on a channel reciprocity associated with the one or more downlink reference signals.

Some examples of the method, UEs, and non-transitory computer-readable medium described herein may further include operations, features, means, or instructions for receiving the one or more downlink reference signals in accordance with the set of multiple CSI report configurations, where the evaluation of the one or more measurements may be based on one or more respective measurements of the one or more downlink reference signals.

In some examples of the method, UEs, and non-transitory computer-readable medium described herein, the one or more downlink reference signals include one or more CSI reference signals.

In some examples of the method, UEs, and non-transitory computer-readable medium described herein, the one or more sub-configurations may be associated with a set of one or more reception antennas of a respective TRP of the set of multiple TRPs.

A method for wireless communication by a network entity is described. The method may include outputting one or more control messages that indicate a set of multiple CSI report configurations, each CSI report configuration includes one or more sub-configurations, where each CSI report configuration of the set of multiple CSI report configurations is associated with a respective TRP of a set of multiple TRPs, outputting an indication to perform an evaluation of one or more measurements associated with one or more downlink reference signals in accordance with one or more combinations of sub-configurations, where each combination of the one or more combinations includes a set of multiple sub-configurations, and where each sub-configuration of each set of multiple sub-configurations is from a respective CSI report configuration, and obtaining a report that indicates one or more antenna ports in accordance with the indication to perform the evaluation.

A network entity for wireless communication is described. The network entity may include a processing system that includes processor circuitry and memory circuitry that stores code. The processing system may be configured to cause the network entity to output one or more control messages that indicate a set of multiple CSI report configurations, each CSI report configuration includes one or more sub-configurations, where each CSI report configuration of the set of multiple CSI report configurations is associated with a respective TRP of a set of multiple TRPs, output an indication to perform an evaluation of one or more measurements associated with one or more downlink reference signals in accordance with one or more combinations of sub-configurations, where each combination of the one or more combinations includes a set of multiple sub-configurations, and where each sub-configuration of each set of multiple sub-configurations is from a respective CSI report configuration, and obtain a report that indicates one or more antenna ports in accordance with the indication to perform the evaluation.

A network entity for wireless communication is described. The network entity may include one or more memories and one or more processors coupled with the one or more memories. The one or more processors may be configured to cause the network entity to output one or more control messages that indicate a set of multiple CSI report configurations, each CSI report configuration includes one or more sub-configurations, where each CSI report configuration of the set of multiple CSI report configurations is associated with a respective TRP of a set of multiple TRPs, output an indication to perform an evaluation of one or more measurements associated with one or more downlink reference signals in accordance with one or more combinations of sub-configurations, where each combination of the one or more combinations includes a set of multiple sub-configurations, and where each sub-configuration of each set of multiple sub-configurations is from a respective CSI report configuration, and obtain a report that indicates one or more antenna ports in accordance with the indication to perform the evaluation.

Another network entity for wireless communication is described. The network entity may include means for outputting one or more control messages that indicate a set of multiple CSI report configurations, each CSI report configuration includes one or more sub-configurations, where each CSI report configuration of the set of multiple CSI report configurations is associated with a respective TRP of a set of multiple TRPs, means for outputting an indication to perform an evaluation of one or more measurements associated with one or more downlink reference signals in accordance with one or more combinations of sub-configurations, where each combination of the one or more combinations includes a set of multiple sub-configurations, and where each sub-configuration of each set of multiple sub-configurations is from a respective CSI report configuration, and means for obtaining a report that indicates one or more antenna ports in accordance with the indication to perform the evaluation.

A non-transitory computer-readable medium storing code for wireless communication is described. The code may include instructions executable by one or more processors to output one or more control messages that indicate a set of multiple CSI report configurations, each CSI report configuration includes one or more sub-configurations, where each CSI report configuration of the set of multiple CSI report configurations is associated with a respective TRP of a set of multiple TRPs, output an indication to perform an evaluation of one or more measurements associated with one or more downlink reference signals in accordance with one or more combinations of sub-configurations, where each combination of the one or more combinations includes a set of multiple sub-configurations, and where each sub-configuration of each set of multiple sub-configurations is from a respective CSI report configuration, and obtain a report that indicates one or more antenna ports in accordance with the indication to perform the evaluation.

Some examples of the method, network entities, and non-transitory computer-readable medium described herein may further include operations, features, means, or instructions for outputting a metric type indication that indicates a communication scheme usable for communications with the set of multiple TRPs, the communication scheme including a joint reception scheme, an SDM scheme, an SFN scheme, a TDM scheme, or any combination thereof, where the one or more antenna ports may be selected in accordance with the communication scheme.

Some examples of the method, network entities, and non-transitory computer-readable medium described herein may further include operations, features, means, or instructions for outputting a metric type indication that indicates an energy efficiency scheme usable for communications with the plurality of TRPs, where the energy efficiency scheme indicates one or more energy efficiency metrics, and where the one or more antenna ports are selected in accordance with the energy efficiency scheme.

Some examples of the method, network entities, and non-transitory computer-readable medium described herein may further include operations, features, means, or instructions for outputting an indication of one or more parameters associated with computation of an uplink spectral efficiency associated with each TRP of the set of multiple TRPs.

Some examples of the method, network entities, and non-transitory computer-readable medium described herein may further include operations, features, means, or instructions for obtaining a message including a first indication of a quantity of ports selected for each combination of the one or more combinations, a second indication of one or more metric values associated with the one or more downlink reference signals in accordance with the evaluation of the one or more measurements, a third indication of a respective metric value associated with each combination of the one or more combinations, or any combination thereof.

Some examples of the method, network entities, and non-transitory computer-readable medium described herein may further include operations, features, means, or instructions for outputting a size indication that indicates a respective quantity of sub-configurations within each combination of the one or more combinations.

### BRIEF DESCRIPTION OF THE DRAWINGS

FIG. 1 shows an example of a wireless communication system that supports antenna subset selection for m-TRP uplink transmissions in accordance with one or more aspects of the present disclosure.

FIG. 2 shows an example of a signaling configuration that supports antenna subset selection for m-TRP uplink transmissions in accordance with one or more aspects of the present disclosure.

FIG. 3 shows an example of a signaling configuration that supports antenna subset selection for m-TRP uplink transmissions in accordance with one or more aspects of the present disclosure.

FIGS. 4A, 4B, 4C, and 4D show examples of communication schemes that support antenna subset selection for m-TRP uplink transmissions in accordance with one or more aspects of the present disclosure.

FIG. 5 shows an example of a process flow that supports antenna subset selection for m-TRP uplink transmissions in accordance with one or more aspects of the present disclosure.

FIG. 6 shows a block diagram of a processing system that supports antenna subset selection for m-TRP uplink transmissions in accordance with one or more aspects of the present disclosure.

FIG. 7 shows a diagram of a system including a device that supports antenna subset selection for m-TRP uplink transmissions in accordance with one or more aspects of the present disclosure.

FIG. 8 shows a block diagram of a processing system that supports antenna subset selection for m-TRP uplink transmissions in accordance with one or more aspects of the present disclosure.

FIG. 9 shows a diagram of a system including a device that supports antenna subset selection for m-TRP uplink transmissions in accordance with one or more aspects of the present disclosure.

FIGS. 10 through 12 show flowcharts illustrating methods that support antenna subset selection for m-TRP uplink transmissions in accordance with one or more aspects of the present disclosure.

Details of aspects of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communications systems, a user equipment (UE) may communicate with a transmission and reception point (TRP) according to a single TRP (s-TRP) scheme, in which the UE communicates with a single TRP. The UE may evaluate one or more reference signal measurements associated with the TRP according to a downlink signal resource or report configuration (e.g., from the TRP, from a network entity associated with the TRP, or both). The UE may modify (e.g., select) one or more parameters associated with communicating with the TRP, such as selecting a subset of antennas for communicating with the TRP. The selection of appropriate antennas and/or subsets of antennas for communications by a UE may have an impact on signaling quality and efficiency. However, there may be differences between uplink s-TRP communications (e.g., communications with a single TRP) and multi-TRP (m-TRP) communications (e.g., communications with more than one TRP). For example, in a multi-TRP scheme, each TRP of a set of one or more (e.g., two or more) TRPs may be associated with a respective (e.g., separate, different) downlink signal resource configuration (e.g., a respective CSI resource configuration), and each TRP of the set of two or more TRPs may be located in different positions (e.g., each TRP may have a different identifier, orientation, arrangement, quasi-colocation (QCL) association, or placement that may impact communication), whereas for s-TRP communications, a single TRP may only be located in one position (e.g., the single TRP may have one identifier). Further, a first TRP located in a first position may be associated with a first downlink signal resource configuration (and a first identifier) and a second TRP located in a second position may be associated with a second downlink signal resource configuration (and a second identifier). These differing positions and configurations among TRPs may affect a reliability of one or more antennas used by the UE for communication with the set of TRPs, thereby increasing the complexity of antenna selection procedures by the UE. Without signaling from the network (e.g., from a network entity, one or more TRPs, or both), the UE may be unable to determine what configurations and/or parameters (e.g., CSI report configurations, CSI resource configurations, calibration parameters, uplink noise plus interference related parameters) to use when evaluating measurements of downlink reference signals from multiple TRPs. Such configurations and parameters may include information (e.g., indicating a position, a placement, a communication scheme, and/or a signaling configuration associated with each TRP of the multiple TRPs) that the UE may use to select antennas for communication with the multiple TRPs. Lacking such information may impact the UE's ability to select the most reliable (e.g., effective) antennas for communicating with multiple TRPs (e.g., antennas which may enable a relatively high data rate or may improve reliability and resilience to errors). Such lack of network signaling may accordingly reduce an ability of the UE to reliably perform m-TRP procedures (e.g., selecting reliable and well suited antennas for m-TRP procedures), thus diminishing the user experience.

Aspects of the subject matter described in this disclosure relate to antenna subset selection for m-TRP uplink transmissions (e.g., selection of antennas at a UE for communication with multiple TRPs). For example, to support antenna subset selection by a UE for transmitting one or more uplink signals to each TRP of a set of multiple TRPs (e.g., to improve reception of the uplink signals from a UE by multiple TRPs), a UE may measure a downlink channel state information (CSI) reference signal (CSI-RS) transmitted from each TRP of a set of two or more TRPs, and the UE may generate a CSI-RS measurement for the downlink CSI-RSs from each TRP. The UE may select a transmit antenna subset of the UE (e.g., an antenna subset used by the UE to transmit in the uplink) according to the resulting CSI-RS measurement for each TRP (e.g., assuming channel reciprocity, where one or more uplink channels used for signal transmission may have similar characteristics to one or more downlink channels used to receive the downlink CSI-RSs). In some cases, the UE may select the transmit antenna for a configured (e.g., indicated) tuple (e.g., combination) of receive antenna port subsets across TRPs (e.g., subsets of TRP receive antennas), where one or more tuples may be indicated to the UE by the network (e.g., by a network entity, by one or more TRPs). The UE may select transmit antennas for communication with multiple TRPs using tuples of receive antenna port subsets, and the UE may communicate with the multiple TRPs using the selected antenna ports. In some examples, the UE may transmit a report that indicates the antenna ports selected by the UE. As described herein, the terms “tuple” and “combination” may be used interchangeably. For example, a tuple of receive antenna port subsets (e.g., two or more TRP antenna port subsets that are included in a tuple) across a set of one or more TRPs may refer to a combination of sub-configurations from one or more CSI report configurations corresponding to respective TRPs. That is, each CSI report configuration may include one or more sub-configurations, and the sub-configurations may be combined and indicated to the UE for evaluation. Combinations of sub-configurations may be indicated to the UE according to one or more formats (e.g., a tuple, a list, a vector, an array, a bitmap, or the like). Techniques described herein may support an uplink m-TRP scheme that allows for time division multiplexing (TDM) repetition, where repetitions of uplink signaling are enabled in a time-division multiplexed manner. Additionally, or alternatively, the techniques described herein may support other types of repetition, diversity and/or schemes such as spatial division multiplexing (SDM) repetition, single frequency network (SFN) repetition, or the like.

In some examples, by supporting selection of UE transmit antennas and TRP receive antenna port subsets for multiple TRPs, the described techniques may be used to improve spectral efficiency for devices within a wireless communications system. For example, by enabling selection of more reliable antenna ports for communication with each TRP on a per-TRP basis, the described techniques may allow for improved communication using a narrower bandwidth (e.g., because more reliable antenna ports may support relatively higher data rates with fewer retransmissions, reducing bandwidth resources needed for successful communication). The disclosed techniques may also improve energy efficiency at UEs and at one or more network entities that include multiple TRPs, for example, by enabling the selection of more reliable antenna ports for communication with each TRP on a per-TRP basis (e.g., based on one or more energy efficiency schemes described herein), which may reduce wasted energy for m-TRP communication (e.g., because selecting reliable antenna ports may reduce the number of failed transmissions and associated retransmission overhead). Further, the techniques described herein may allow a UE to select reliable (e.g., suitable) antenna ports for communicating with each TRP according to an m-TRP scheme, for example, based on TRP-specific configurations and positioning information.

As described herein, a CSI report configuration may refer to a configuration (e.g., one or more parameters or indications) that a UE may use to transmit a CSI report based on one or more reference signals (e.g., CSI-RSs). In some cases, a CSI report configuration may include information as described herein that a UE may use to evaluate measurements of reference signals and to select antenna ports for communication with multiple TRPs. A CSI report configuration may be associated with a particular TRP and may include one or more sub-configurations. A sub-configuration may be associated with a set of one or more reception antennas or reception antenna ports of a particular TRP. For example, a sub-configuration may identify one or more parameters associated with a set of one or more reception antennas of a TRP associated with the sub-configuration. A TRP may refer to one or more entities having a capability to transmit and receive signals at a network entity (e.g., using one or more antenna ports of the TRP). For example, a TRP may refer to one or more devices that each include a set of co-located antenna elements that are configured to support transmission and reception of wireless signals.

As described herein, a combination (e.g., a combination of sub-configurations) may refer to a set (e.g., a list, a tuple, an array, a vector) of values that identify one or more sub-configurations (e.g., associated with respective TRPs). The terms “combination” and “tuple” may be used interchangeably. For example, a tuple of receive antenna port subsets across a set of one or more TRPs may refer to a combination of sub-configurations included in one or more CSI report configurations corresponding to respective TRPs. Combinations of sub-configurations may be indicated according to one or more formats (e.g., a tuple, a list, a vector, an array, a bitmap, or the like). As described herein, the term “antenna port” (as in antenna port subset) may refer to a logical entity. For example, each receive antenna port of a set of receive antenna ports may be a logical entity that may be associated with a signal obtained as a linear filtering (combining) of signals received over a set of antennas (e.g., a signal associated with a receive antenna port which is also referred to as the signal received over the receive antenna port, may refer to, or may be equivalent to, a weighted sum of signals received over a set of antennas, with the weights being complex scalars). As a special case, a receive antenna port may correspond to an antenna such that a signal received over the receive antenna port is an example of (e.g., equivalent to) a signal received by the antenna.

A transmit antenna port at the UE may refer to a transmit antenna at the UE. It may also refer to a logical entity realized using a set of antennas so that a signal transmitted by the transmit antenna port corresponds to the weighted version of that signal simultaneously transmitted by each antenna in the set of antennas (where the weight is a complex scalar and may be different for different antennas in the set). In some cases, an entity (e.g., a UE) may receive one or more reference signals via antennas and perform one or more measurements based on the one or more reference signals. As described herein, the term “measurement” may refer to one or more evaluations of quality associated with signals, which may be represented by one or more values (e.g., a receive power, a receive quality, or the like). As described herein, the term “channel reciprocity” may refer to a characteristic of multiple channels (e.g., one or more uplink channels and one or more downlink channels) that indicates that the multiple channels have one or more similar characteristics (e.g., such that an entity may infer channel characteristics of one channel based on channel characteristics of another channel). Channel reciprocity may enable a device (e.g., a UE, a network entity) to determine one or more characteristics associated with a first channel (e.g., an uplink channel) based on one or more characteristics measured (e.g., determined, calculated) for a second channel (e.g., based on reference signals received via a downlink channel).

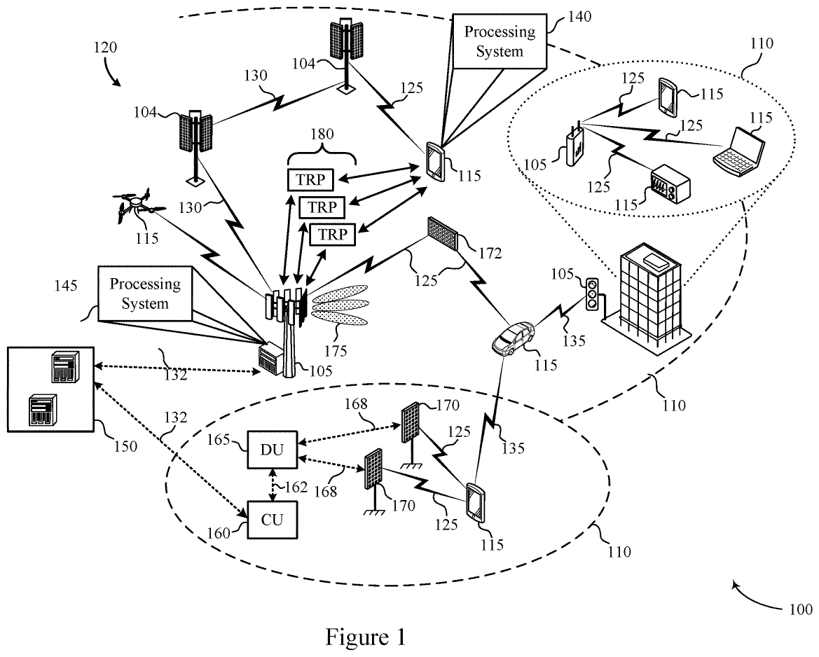

FIG. 1 shows an example of a wireless communication system 100 that supports antenna subset selection for multi-transmission and reception point (m-TRP) uplink transmissions in accordance with one or more aspects of the present disclosure. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105.

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a ULE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, CSI-RSs that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Techniques described herein, in addition to or as an alternative to be carried out between UEs 115 and network entities 105, may be implemented via additional or alternative wireless devices, including IAB nodes 104, distributed units (DUs) 165, centralized units (CUs) 160, radio units (RUs) 170, and the like. An RU 170 may also be referred to as a radio head, a smart radio head, a remote radio head (RRH), a remote radio unit (RRU), or a TRP. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 175 is flexible and as such gives rise to numerous permutations of different functionalities depending upon which functions (e.g., MAC functions, baseband functions, radio frequency functions, and any combinations thereof) are performed at the CU 160, DU 165, and RU 175. For example, a functional split of the protocol stack may be employed between a DU 165 and an RU 170 such that the DU 165 may support one or more layers of the protocol stack and the RU 170 may support one or more different layers of the protocol stack.

Some wireless communication systems (e.g., wireless communication system 100), infrastructure and spectral resources for NR access may additionally support wireless backhaul link capabilities in supplement to wireline backhaul connections, providing an IAB network architecture. One or more network entities 105 may include CUs 160, DUs 165, and RUs 170 and may be referred to as donor network entities 105 or IAB donors. One or more DUs 165 (e.g., and/or RUs 170) associated with a donor network entity 105 may be partially controlled by CUs 160 associated with the donor network entity 105. The one or more donor network entities 105 (e.g., IAB donors) may be in communication with one or more additional network entities 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communication system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of network entities 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a network entity 105 may additionally, or alternatively, be performed by components of the disaggregated RAN architecture (e.g., IAB nodes, DUs, CUs, etc.).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some wireless communications systems, a UE may perform antenna selection for s-TRP uplink (e.g., for a single TRP) by adapting a CSI resource configuration (e.g., CSI-Resource-config) to specify evaluation of multiple receive TRP port subset hypotheses. However, s-TRP reception and m-TRP reception may have significant differences, which may result in challenges for a UE communicating with multiple TRPs without additional signaling. For example, for an uplink reception scheme with multiple TRPs (e.g., two TRPs), each TRP may have a distinct identifier and may have a distinct (e.g., different) QCL association (e.g., differing QCL-type D associations). Consequently, without a CSI resource configuration for each of the multiple TRPs, the UE may be unable to reliably select antenna ports for communicating with each TRP.

In some implementations, a UE 115 may be configured to evaluate one or more receive hypotheses using one sub-config from each CSI resource configuration corresponding to each TRP 180 of a set of TRPs 180. For example, the UE 115 may evaluate one subset of receive ports for each TRP 180 of the set of TRPs 180. The UE 115 may receive an indication (e.g., from a network entity) to jointly consider multiple subsets across multiple CSI resource configurations in an evaluation to select antenna subsets for communication with the multiple TRPs 180. In some cases, the UE 115 may perform the evaluation based on a metric (e.g., a scheme) that may be configured (e.g., tailored, dynamically configured). For example, the UE 115 may perform the evaluation based on an SDM scheme (e.g., targeting an SDM scheme for m-TRP communication), where a subset of layers may be intended for (e.g., allocated for) each TRP 180 of the set of TRPs 180. In some examples, the UE 115 may perform the evaluation according to a TDM scheme (e.g., with repetition) or according to an SFN scheme. Additionally, or alternatively, the UE 115 may perform the evaluation based on a transmission by the UE 115 targeting joint reception by all TRPs 180 (e.g., all layers may be intended for reception by all TRPs 180). In some cases, the UE 115 may receive configuration signaling that indicates a metric or a scheme for the evaluation. Accordingly, the UE 115 may perform the evaluation based on a configured scheme for m-TRP communications.

Devices of the wireless communication system 100 may be configured to support one or more aspects of the described techniques for antenna subset selection for m-TRP uplink transmissions. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support antenna selection based on CSI-RS for m-TRP uplink reception. For example, a UE 115 may measure one or more downlink CSI-RSs from each TRP 180 of a set of TRPs 180. Based on the measurements, one or more indicated parameters and channel reciprocity, the UE 115 may select a transmit antenna subset of the UE 115 (e.g., an antenna subset used by the UE 115 to transmit in the uplink) according to CSI-RS measurements for each TRP (e.g., assuming channel reciprocity, where one or more uplink channels used for signal transmission may have similar characteristics to one or more downlink channels used to receive the downlink CSI-RSs). The UE 115 may perform the selection for one or more configured (e.g., indicated) tuples of receive antenna port subsets across a set of TRPs 180 (e.g., according to an m-TRP scheme). In some cases, m-TRP reception may be considered (e.g., conceptually) as similar to s-TRP reception (e.g., a UE may receive individual reference signals from each TRP 180 of a set of TRPs 180). However, an m-TRP scheme may involve distributed antenna groups of a TRP (e.g., one or more antenna groups at each TRP of a set of TRPs) as described herein.

A UE 115 may perform one or more procedures to support antenna subset selection for m-TRP uplink transmissions. The UE 115 may receive one or more control messages that indicate a set of CSI report configurations (e.g., associated with respective CSI resource configurations). Each CSI report configuration of the set may include one or more sub-configurations of a set of sub-configurations (e.g., the one or more sub-configurations of each CSI report configuration make up the set of sub-configurations). Each CSI report configuration of the set of CSI report configurations may be associated with a respective TRP 180 of a set of TRPs 180. The UE 115 may receive an indication to perform an evaluation of measurements associated with one or more downlink reference signals (e.g., CSI-RSs). The UE 115 may perform the evaluation of measurements in accordance with one or more combinations (e.g., tuples) of the set of sub-configurations from respective CSI report configurations. Accordingly, the UE 115 may select one or more antenna ports in accordance with the evaluation of the measurements. The UE 115 may communicate with the set of TRPs 180 via the one or more antenna ports. In some cases, the UE 115 may transmit a report that indicates the one or more antenna ports selected by the UE 115. In any case, the UE 115 and a corresponding network entity may exchange signaling to support configurations for m-TRP communication.

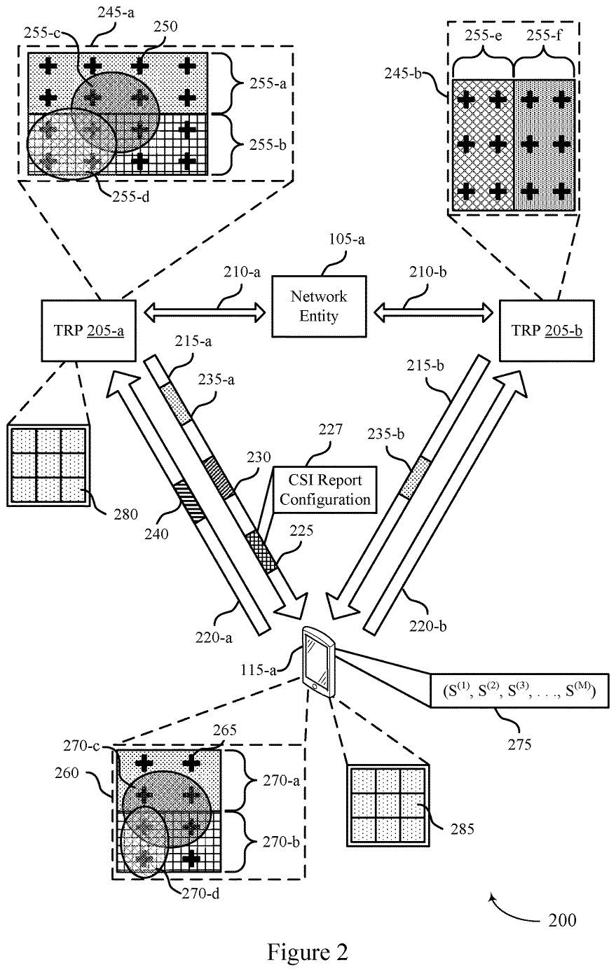

FIG. 2 shows an example of a signaling configuration 200 that supports antenna subset selection for m-TRP uplink transmissions in accordance with one or more aspects of the present disclosure. In some cases, the signaling configuration 200 may implement or be implemented by aspects of the wireless communication system 100. For example, the signaling configuration 200 may include one or more UEs 115 (e.g., a UE 115-a) and one or more network entities 105 (e.g., a network entity 105-a), which may be examples of the corresponding devices as described herein. The network entity 105-a (including one or more network nodes) may be in communication with multiple TRPs 205 (e.g., a TRP 205-a, a TRP 205-b) via respective communication links 210 (e.g., communication link 210-a, communication link 210-b), which may be physical links or wireless links. The UE 115-a may support communication with the multiple TRPs 205 based on signaling as described herein. For example, the UE 115-a may receive one or more messages from the TRP 205-a via a wireless communication link 215-a (e.g., a downlink channel) and may transmit one or more messages to the TRP 205-a via a wireless communication link 220-a (e.g., an uplink channel). Similarly, the UE 115-a may receive one or more messages from the TRP 205-b via a wireless communication link 215-b (e.g., a downlink channel) and may transmit one or more messages to the TRP 205-b via a wireless communication link 220-b (e.g., an uplink channel).

Each TRP 205 may receive uplink communications or transmit downlink communications using an antenna array 245 that is associated with one or more antenna ports 250. For example, each TRP 205 may include a set of multiple antennas 280 (which may be referred to as antenna elements), and the antenna elements may be associated with the antenna ports 250. In some cases, each TRP 205 may include one or more antenna arrays 245. For example, the TRP 205-a may communicate using an antenna array 245-a that is associated with one or more antenna port subsets 255 (e.g., antenna port subset 255-a, antenna port subset 255-b, antenna port subset 255-c, antenna port subset 255-d), which each include one or more antenna ports 250. Similarly, the TRP 205-b may communicate using an antenna array 245-b that is associated with one or more antenna port subsets 255 (e.g., antenna port subset 255-e, antenna port subset 255-f), which each include one or more antenna ports 250. As described herein, antennas 280 may be contiguous (e.g., a group of antennas 280 that are adjacent to one another) or non-contiguous (e.g., a group of antennas 280 that are not all adjacent to one another) and associated with an antenna array 245. In some implementations, the UE 115-a may receive downlink communications and may transmit uplink communications using an antenna array 260 that is associated with one or more antenna ports 265 (e.g., corresponding to one or more antennas 285 of the UE 115-a). For example, the antenna array 260 may be associated with one or more antenna port subsets 270 (e.g., antenna port subset 270-a, antenna port subset 270-b, antenna port subset 270-c, antenna port subset 270-d), which each include one or more antenna ports 265. An antenna port subset 270 may include one or more antenna ports 265 that are contiguous or non-contiguous within the antenna array 260 (e.g., associated with antennas 285 that are adjacent or non-adjacent).

In some implementations, the network entity 105-a may transmit one or more control messages 225 to the UE 115-a (e.g., via one or more TRPs 205) to support m-TRP reception using multiple (e.g., two or more) TRPs 205. For example, the network entity 105-a may configure (e.g., via the one or more control messages 225) one or more CSI report configurations 227 and one or more CSI resource configurations for each TRP 205 (e.g., CSI-report-config-1 and CSI-resource-config-1 for the TRP 205-a and CSI-report-config-2 and CSI-resource-config-2 for the TRP 205-b). In some cases, the one or more control messages 225 may include a network indication that indicates for the UE 115-a to jointly consider one or more pairs of sub-configurations (e.g., subsets of receive antennas, one or more antenna port subsets 255). Each pair of the one or more pairs may include a first sub-configuration from a first CSI report configuration 227 (e.g., CSI-report-config-1), a second sub-configuration from a second CSI report configuration 227 (e.g., CSI-report-config-2), or both. In some examples, the UE 115-a may evaluate one or more combined subsets for uplink multi-TRP reception based on one or more network guided metrics (e.g., metrics configured by the network entity 105-a) as described herein. In some implementations, the UE 115-a may individually consider one or more antenna port subsets 255 (e.g., the antenna port subset 255-d of the TRP 205-a). Additionally, or alternatively, the UE 115-a may jointly consider multiple antenna port subsets 255 (e.g., the antenna port subset 255-a and the antenna port subset 255-b of the TRP 205-a, and the antenna port subset 255-e of the TRP 205-b).

In some implementations, the signaling configuration 200 may support a network configuration that enables antenna subset selection by the UE 115-a for uplink reception using multiple TRPs (e.g., in accordance with an m-TRP scheme). The network entity 105-a may configure a CSI report configuration 227 (e.g., CSI-Report-config via the one or more control messages 225) and a CSI resource configuration (e.g., CSI-Resource-config) for each TRP 205 of a set of TRPs 205 as described herein (e.g., a CSI-Report-config-n and CSI-Resource-config-n for each TRP-n, where n may be an identifier or index of a TRP). In some cases, as described herein, a CSI resource configuration may include or may correspond to a CSI report configuration 227. In some implementations, the UE 115-a may receive a network indication 230 that indicates for the UE 115-a to evaluate one or more combinations 275 (e.g., tuples) of sub-configurations. Each combination 275 (e.g., tuple) may include up to a threshold quantity of sub-configurations (e.g., up to one sub-configuration from each CSI resource configuration (or from each CSI report configuration 227)). For example, the one or more control messages 225 may indicate a tuple (e.g., a set, a combination 275) of sub-configurations (S⁽¹⁾, S⁽²⁾, S⁽³⁾, . . . , S^{(M)}), where S^{(j)} represents a sub-configuration selected for a j^{th} TRP of the set of TRPs 205. In some cases, a particular sub-configuration SP may indicate (e.g., equal) a null value (or another configured value, such as ‘0’ or ‘−1’) for a particular tuple, which may indicate that no sub-configuration is to be selected for the k^{th} TRP in the particular tuple.

In some implementations, the UE 115-a may evaluate one or more indicated combinations 275 (e.g., tuples) for uplink m-TRP reception based on a metric corresponding to each combination 275. For example, the UE 115-a may evaluate (S⁽¹⁾, S⁽²⁾, S⁽³⁾, . . . , S^{(M)}) assuming uplink m-TRP reception in which the k^{th} TRP may receive using the antenna ports in S^{(k)} for 1≤k≤M (e.g., for each TRP 205). In some cases, the network entity 105-a may guide an uplink metric used to evaluate (e.g., assess) each combination 275. In some examples, the UE 115-a may receive one or more parameters to enable evaluation of the one or more combinations 275 by the UE 115-a. The UE 115-a may output, based on an evaluation of each combination 275, a selected UE transmit antenna subset and an associated metric value associated with each combination 275. For example, the UE 115-a may evaluate (e.g., compare, measure according to sub-configurations) the measurements associated with a first set of TRPs 205 for a first combination that indicates sub-configurations for each TRP 205 of the first set of TRPs 205. Accordingly, the UE 115-a may select a first set of antenna ports for communication with the first set of TRPs in accordance with the evaluation of the measurements. Similarly, the UE 115-a may select a second set of antenna ports for communication with a second set of TRPs 205 in accordance with an evaluation of measurements in accordance with a second combination that indicates sub-configurations for each TRP 205 of the second set of TRPs 205 (e.g., the UE may evaluate the measurements based on parameters within the sub-configurations).

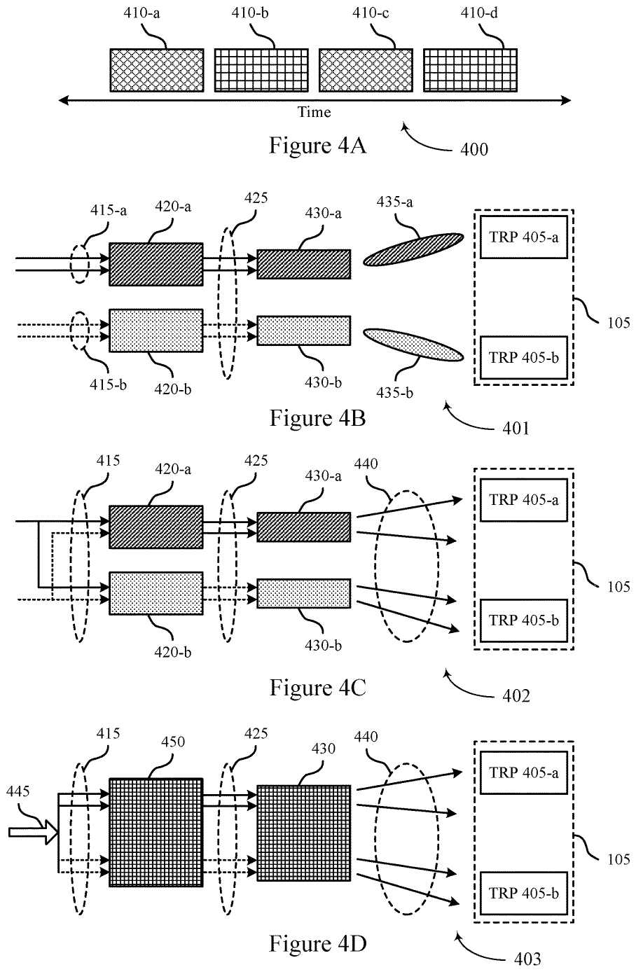

In some implementations, the network indication 230 (or another downlink message as described herein) may include one or more parameters that enable antenna selection for m-TRP reception based on one or more reference signals (e.g., CSI-RSs). For example, the network indication 230 may include a metric type indication that indicates a metric that accounts for a type of physical uplink shared channel (PUSCH) uplink m-TRP reception (e.g., a main intended type of PUSCH uplink m-TRP reception corresponding to each TRP 205). In some cases, each TRP 205 may transmit a metric type indication to the UE 115-a (such that the UE 115-a may use a metric type indication for evaluating a sub-configuration corresponding to each TRP 205). The metric type indication may indicate a communication scheme (e.g., a metric type) associated with communication at each TRP 205. For example, for each TRP 205, the metric type indication may indicate that a respective TRP is associated with one or more communication schemes such as a joint reception communication scheme, an SDM communication scheme, an SFN communication scheme, a TDM communication scheme (e.g., with weights), an energy efficiency scheme, or any combination thereof. In some cases, one or more communication schemes (e.g., joint reception communication scheme, SDM communication scheme) described herein may refer to types of an energy efficiency scheme (since the one or more communication schemes described herein may have different associated energy efficiency at one or more TRPs or devices described herein. Indicated weights may also allow the network to indicate a scheme, e.g. TDM scheme, with tailored associated energy efficiency depending on the indicated weights). A joint reception communication scheme may refer to a scheme in which a set of transmitted layers (e.g., all transmitted layers) may be bound (e.g., intended) for reception by each TRP of the set of TRPs 205 (e.g., all TRPs). An SDM communication scheme may refer to a scheme in which different subsets of transmitted layers may be intended for reception by different TRPs (e.g., one or more transmitted layers intended for each TRP). An SFN communication scheme may refer to a scheme in which different subsets of transmitted layers may be intended for reception by multiple TRPs (e.g., one or more transmitted layers intended for a set of multiple TRPs). A TDM communication scheme (with weights) may refer to a scheme in which one or more weights (e.g., values) may indicate duty cycles associated with reception by each TRP. In such a scheme, one or more layers transmitted at each transmit occasion may be intended for a particular (e.g., specific) TRP. Further details regarding such communication schemes are further illustrated and described herein with reference to FIGS. 4A-4D.

In some implementations, each TRP 205 (or the network entity 105-a, or both) may indicate, to the UE 115-a, one or more parameters for computing uplink spectral efficiency. The one or more parameters may include a quantization distortion indication (e.g., on a per-TRP basis or a common quantization distortion indication for all TRPs). For example, the network entity 105-a may enforce one or more front-haul constraints via quantization. In some cases, one or more entities (e.g., the UE 115-a, the network entity 105-a) may model an impact of quantization distortion using a scaling of a channel matrix and a quantization noise covariance matrix (e.g., based on a Bussgang or an additive quantization noise model). In some examples, the one or more parameters may include a covariance matrix (e.g., an interference covariance matrix, an Rnn covariance matrix) that indicates uplink noise and interference (e.g., noise plus interference) observed (e.g., recorded, received) at each TRP 205. In some cases, the covariance matrix may include information associated with uplink noise and interference on a per-TRP basis or (optionally) on a per-sub-band basis (e.g., indicating noise and interference for each sub-band of a set of sub-bands used at each TRP 205). For example, the information associated with uplink noise and interference may be indicated on a sub-band basis either as a full matrix or partially as diagonal elements.

In some cases, the one or more parameters may include one or more calibration parameters (e.g., parameters associated with calibrating transmit antennas at the UE 115-a, the receive antennas at the one or more TRPs 205, or a combination thereof). The one or more calibration parameters may be indicated per-TRP, per-port (e.g., per antenna port), or both. In some examples, the one or more calibration parameters may model (e.g., indicate) a mismatch between transmit RF chains and receive RF chains that are connected to a same antenna port (e.g., for each TRP). Additionally, or alternatively, the one or more parameters may include a range of rank or a quantity of layers. For example, the one or more parameters may include one or more threshold ranks (e.g., a minimum rank, a maximum rank, or both) that the network entity 105-a may assign (e.g., which the network entity 105-a intends to assign). In some examples, the one or more parameters may include sub-band sets, transmit power masks or limits, or both. In any case, the one or more parameters may be common for all tuples (e.g., for each and every combination 275) or may be separately indicated for one or more tuples (e.g., a respective set of one or more parameters for each combination 275 of the one or more combinations 275).

In some implementations, the UE 115-a may receive one or more reference signals 235 (e.g., CSI-RSs) from the one or more TRPs 205. For example, the UE 115-a may receive one or more reference signals 235-a from the TRP 205-a, one or more reference signals 235-b from the TRP 205-b, and so on for one or more additional TRPs. In some cases, the UE 115-a may receive and measure the one or more reference signals 235 based on the one or more control messages 225, the network indication 230, or both, which may result in one or more measurements associated with the one or more reference signals 235. The UE 115-a may perform an evaluation of the one or more measurements according to the network indication 230, including one or more parameters as described herein.

In some implementations, the UE 115-a may transmit one or more reports 240 to the TRP 205-a (and one or more other TRPs 205) based on the evaluation of the one or more measurements. In some examples, the UE 115-a may indicate one or more values based on the evaluation (e.g., as part of the one or more reports 240 or as a separate message). For example, the one or more values may include a quantity (and optionally a composition) of uplink ports selected by the UE 115-a for each combination 275 (e.g., tuple) of sub-configurations. In some cases, the one or more values may include one or more computed metric values (e.g., resulting from the evaluation of the one or more measurements). The one or more computed metric values may include measurements or other calculated values (e.g., quality metrics) associated with one or more uplink ports selected (or not selected) by the UE 115-a for each combination 275. In some cases, the UE 115-a may indicate a quantity (or composition, or both) of uplink ports selected by the UE 115-a for a threshold quantity of combinations 275 (e.g., tuples) of sub-configurations (e.g., a top-k pre-configured tuples). In some examples, the threshold quantity of combinations 275 may be configured or calculated based on one or more metrics associated with the one or more combinations 275 in accordance with the evaluation of the one or more measurements. Additionally, or alternatively, the UE 115-a may report (e.g., indicate) a union of all selected ports (e.g., distinct selected ports) for each combination 275 of the one or more combinations 275 of sub-configurations, for the threshold quantity of combinations 275, or both. In some cases, the UE 115-a may transmit the one or more reports 240 (and one or more other messages) via UCI, via a MAC-control element (MAC-CE), via a message triggered by one or more events (e.g., handover, connection establishment), or any combination thereof.

In some implementations, the signaling configuration 200 may support a variable size indication for (e.g., associated with) the one or more combinations 275 of sub-configurations. For example, the network entity 105-a may indicate a size of each combination 275 of the one or more combinations 275 of sub-configurations. For example, each size indication of a set of size indications (e.g., indicated by the network entity 105-a to the UE 115-a) may indicate a quantity of TRPs, followed by a TRP identifier associated with each TRP 205 of the quantity of TRPs and a sub-configuration identifier for each TRP 205 of the quantity of TRPs. Each size indication of the set of size indications may correspond to a respective combination 275 of the one or more combinations 275. In some cases, the network entity 105-a may provide a response to the one or more reports 240. For example, the response may acknowledge feedback from the UE 115-a (e.g., a report acknowledgment). Additionally, or alternatively, the response may indicate a selected combination 275 (e.g., tuple) of sub-configurations (e.g., selected by the UE 115-a, by the network entity 105-a, or both). For example, the one or more reports 240 may select and indicate a set of one or more combinations 275 (e.g., based on the evaluation of the one or more measurements). Accordingly, the network entity 105-a may select a combination 275 from the set of one or more combinations 275 (e.g., preferred by the network entity 105-a). In some implementations, the UE 115-a may be configured to determine (e.g., deduce) one or more configurations for other reference signal transmissions (e.g., sounding reference signal (SRS) transmissions) based on the response from the network entity 105-a. For instance, the UE 115-a may determine (e.g., infer) an uplink subset (e.g., an antenna port subset 270) selected by the UE 115-a for the combination 275 (e.g., tuple) of sub-configurations indicated by the network entity 105-a. Based on such a determination (e.g., inference) and a corresponding metric type, the UE 115-a may determine a quantity of sounding ports (e.g., antenna ports 265) for each associated SRS transmission.

In some implementations, the network entity 105-a may indicate (e.g., define), to the UE 115-a, multiple antenna port subsets 255 formed from antenna ports 250 (e.g., CSI-RS ports) of one downlink reference signal resource (e.g., CSI-RS resource) defined for a TRP 205. Additionally, or alternatively, the network entity 105-a may indicate, to the UE 115-a, multiple antenna port subsets 255 from multiple downlink reference signal resources (e.g., CSI-RS resources) defined for the TRP 205. Accordingly, the signaling configuration 200 may support one or more channel state feedback (CSF) frameworks (e.g., Type2 CSF framework) in network energy savings (NES) for antenna subset selection for m-TRP reception.

In some implementations, the UE 115-a may perform one or more operations (e.g., matrix calculations) to determine an uplink model of a sub-band at a particular TRP 205. For example, the UE 115-a may perform a calculation according to formula (1) to determine uplink model information y. One or more parameters of formula (1) may be determined or indicated by the network entity 105-a as described herein.

$$y = {P}^{TRP} {A}^{TRP} {HP}^{UE} + n \qquad ( 1 )$$

where P^{TRP} is a TRP port selection matrix (e.g., a receive port hypothesis) corresponding to the particular TRP 205, A^{TRP} is a calibration adjustment for the particular TRP 205, H is an uplink channel matrix with dimensions M×N (M is a quantity of TRP ports and N is a quantity of UE ports), P^{UE} is a UE port selection matrix (e.g., corresponding to transmit port selection), and n corresponds to a noise plus interference observed at the particular TRP 205 (e.g., with covariance Rnn). In some cases, the UE 115-a may calculate a scalar quantization gain and covariance noise vector z according to formula (2) (e.g., a function of quantization bit-width and scalar quantization codebook).

$$z = Q ( y ) \approx α y + {v}_{Q} \qquad ( 2 )$$

where Q is an element-wise quantization, a is a scalar quantization gain, an v_{Q} is a quantization noise vector.

In some implementations, by supporting selection of UE transmit antennas and receive antenna port subsets for multiple TRPs 205 (e.g., the TRP 205-a and the TRP 205-b), the techniques described herein may be used to improve spectral efficiency for devices within the signaling configuration 200. These techniques may also improve energy efficiency at the UE 115-a, at the network entity 105-a, and at the multiple TRPs 205 (e.g., based on using one or more energy efficiency schemes described herein). For example, by enabling the selection of more reliable antenna ports for communication with each TRP on a per-TRP basis (e.g., based on one or more energy efficiency schemes described herein), these techniques may reduce wasted energy for m-TRP communication. Further, the techniques described herein may allow the UE 115-a to select reliable (e.g., suitable) antenna port subsets 270 for communicating with each TRP 205 according to an m-TRP scheme.

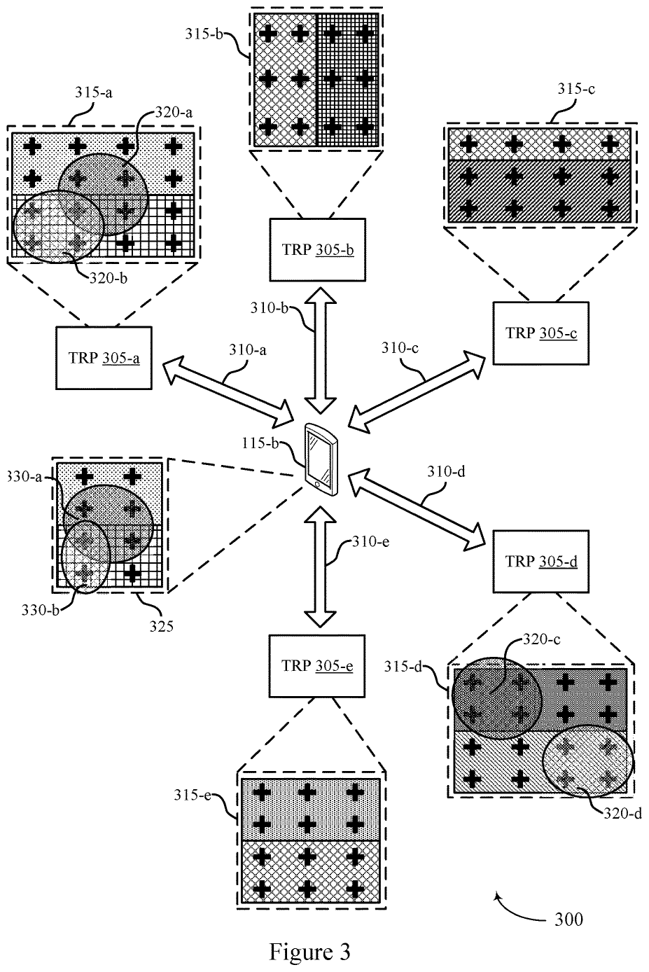

FIG. 3 shows an example of a signaling configuration 300 that supports antenna subset selection for m-TRP uplink transmissions in accordance with one or more aspects of the present disclosure. The signaling configuration 300 includes a UE 115-b and a set of TRPs 305 (e.g., TRP 305-a, TRP 305-b, TRP 305-c, TRP 305-d, TRP 305-e), which may be examples of the corresponding devices as described herein with respect to FIGS. 1 and 2. Each TRP 305 of the set of TRPs 305 may include an antenna array 315 that is associated with one or more antenna port subsets 320 (e.g., antenna port subset 320-a and antenna port subset 320-b corresponding to TRP 305-a, and antenna port subset 320-c and antenna port subset 320-d corresponding to TRP 305-d). As an example, the TRP 305-a may include a first antenna array 315-a, the TRP 305-b may include a second antenna array 315-b, the TRP 305-c may include a third antenna array 315-c, the TRP 305-d may include a fourth antenna array 315-d, the TRP 305-e may include a fifth antenna array 315-e, and so forth. Similarly, the UE 115-b may include an antenna array 325 that is associated with one or more antenna port subsets 330 (e.g., antenna port subset 330-a, antenna port subset 330-b). The UE 115-b may communicate with each TRP 305 of the set of TRPs 305 via the antenna array 325, and via a respective wireless communication link 310 (e.g., a wireless communication link 310-a, a wireless communication link 310-b, a wireless communication link 310-c, a wireless communication link 310-d, and a wireless communication link 310-e). Although five TRPs are illustrated in the signaling configuration 300, the techniques described herein may be equally applied for other quantities of TRPs (e.g., greater or larger than five).

In some implementations, a network entity 105 may configure a CSI report configuration and an associated CSI resource configuration for each TRP 305, and may transmit such configurations to the UE 115-b (e.g., using one or more TRPs 305, via one or more control messages). The UE 115-b may also receive one or more combinations (e.g., tuples) of sub-configurations. Each sub-configuration may correspond to a respective CSI report configurations. For example, each combination (e.g., tuple) may have one or more sub-configurations from one or more CSI Report configurations (e.g., one or more port subsets from different CSI Resource configurations associated with different TRPs). In some cases, one or more TRPs 305 may not have a respective sub-configuration (e.g., antenna port subset 320) in one or more combinations (e.g., a tuple may have sub-configurations for a subset of TRPs, or the entire set of TRPs). For example, a first combination (e.g., tuple) may indicate the antenna port subset 320-a of the TRP 305-a and the antenna port subset 320-c of the TRP 305-d, and may indicate a null value (e.g., an empty value) for TRP 305-b, TRP 305-c, and TRP 305-e. Additionally, or alternatively, a second combination may indicate a respective antenna port subset 320 for each TRP 305 (or a subset of TRPs 305).

In some examples, a same subset of ports of a TRP 305 may appear in one or more combinations (e.g., tuples). For example, a first combination and a third combination may each include (e.g., indicate) the antenna port subset 320-b corresponding to the TRP 305-a. In some implementations, for an evaluation of measurements to select one or more transmit antennas for communication with one or more TRPs 305, the UE 115-a may jointly consider multiple antenna port subsets 320 corresponding to multiple TRPs. Similarly, the UE 115-a may individually consider an antenna port subset 320 (e.g., the antenna port subset 320-d corresponding to TRP 305-d) to select one or more transmit antennas for communication with a corresponding TRP (e.g., the TRP 305-d). Additionally, or alternatively, the network entity 105 may configure one CSI report configuration for the UE 115-b. The CSI report configuration for the UE 115-b may include one or more combinations (e.g., tuples). Each combination may identify one or more associated pairs (e.g., a pair in the form: subset, CSI-Resource-config Id). Each associated pair may include an antenna port subset 320 and a CSI resource configuration identifier. For example, each associated pair may identify an antenna port subset 320 of a CSI resource configuration corresponding to a respective TRP. Each combination may associate each antenna port subset 320 with a respective CSI resource configuration identifier.

In some implementations, by supporting selection of UE transmit antennas and receive antenna port subsets for multiple TRPs 305 (e.g., the TRP 305-a, the TRP 305-b, the TRP 305-c, the TRP 305-d, and the TRP 305-e), the techniques described herein may be used to improve spectral efficiency for devices within the signaling configuration 300 (e.g., using an energy efficiency scheme). These techniques may also improve energy efficiency at the UE 115-b and at one or more network entities 105 associated with the multiple TRPs 305. Further, the techniques described herein may allow the UE 115-b to select reliable (e.g., suitable) antenna port subsets 330 for communicating with each TRP 305 according to an m-TRP scheme.

FIGS. 4A, 4B, 4C, and 4D illustrate examples of communication schemes that support antenna subset selection for m-TRP uplink transmissions in accordance with one or more aspects of the present disclosure. FIGS. 4A-4D may implement or be implemented by one or more aspects described herein with reference to FIGS. 1-3. For example, a UE 115 may receive a metric type indication that indicates one or more metric types, communication schemes, or both, associated with communicating with one or more TRPs 405 (e.g., an energy efficiency scheme, one or more energy efficiency metrics). The UE 115 may perform an evaluation of one or more measurements of reference signals from the one or more TRPs 405 based on the indicated metric types or communication schemes. The UE 115 may receive one or more control messages 225 that indicate a set of CSI report configurations 227. Each CSI report configuration 227 of the set may include one or more sub-configurations of a set of sub-configurations. Each CSI report configuration 227 of the set of CSI report configurations 227 may be associated with a respective TRP of a set of TRPs 405. The UE 115 may receive an indication to perform an evaluation of measurements associated with one or more downlink reference signals, along with a metric type indication as described herein. The UE 115 may perform the evaluation of measurements in accordance with one or more combinations (e.g., tuples) of the set of sub-configurations from respective CSI report configurations 227 and the metric type indication. Accordingly, the UE 115 may select one or more antenna ports in accordance with the evaluation of the measurements. The UE 115 may communicate with the set of TRPs 405 via the one or more antenna ports (and may thus communicate with a network entity 105 associated with the set of TRPs 405).

FIG. 4A shows an example of a TDM communication scheme 400 that supports antenna subset selection for m-TRP uplink transmissions in accordance with one or more aspects of the present disclosure. In accordance with the TDM communication scheme 400, a UE 115 may receive a downlink control information (DCI) message that schedules a set of repetitions 410 (e.g., four PUSCH repetitions). A first subset of repetitions 410 (e.g., repetition 410-a and repetition 410-c) may be associated with a first reference signal resource set (e.g., SRS resource set, CSI-RS resource set). The UE 115 may transmit the first subset of repetitions 410 to a TRP 405-a (e.g., targeting the TRP 405-a). For example, the first subset of repetitions 410 may use a first precoding scheme targeted toward the TRP 405-a. Similarly, a second subset of repetitions 410 (e.g., repetition 410-b and repetition 410-d) may be associated with a second reference signal resource set. The UE 115 may transmit the second subset of repetitions 410 to a TRP 405-b (e.g., targeting the TRP 405-b). For example, the second subset of repetitions 410 may use a second precoding scheme targeted toward the TRP 405-b.

FIG. 4B illustrates an example of an SDM communication scheme 401 that supports antenna subset selection for m-TRP uplink transmissions in accordance with one or more aspects of the present disclosure. In accordance with the SDM communication scheme 401, a UE 115 may transmit a first set of layers 415-a and a second set of layers 415-b. In some cases, the first set of layers 415-a may be intended for a TRP 405-a and the second set of layers 415-b may be intended for a TRP 405-b. For example, the UE 115 may use, for the first set of layers 415-a, a resource indicator 420-a (e.g., an SRS resource indicator (SRI)), a set of PUSCH ports 425, and a panel 430-a prior to transmitting the first set of layers 415-a. In some examples, the UE 115 may transmit the first set of layers 415-a (e.g., layer 0 and layer 1) via a first transmit beam 435-a (e.g., a first transmission configuration indicator (TCI) state). Similarly, the UE 115 may use, for the second set of layers 415-b, a resource indicator 420-b (e.g., an SRI), a set of PUSCH ports 425, and a panel 430-b prior to transmitting the second set of layers 415-b. In some examples, the UE 115 may transmit the second set of layers 415-b (e.g., layer 2 and layer 3) via a second transmit beam 435-b (e.g., a second TCI state). In some implementations, the TRP 405-b may treat the first set of layers 415-a as interference and the TRP 405-a may treat (e.g., observe, receive) the second set of layers 415-b as interference (e.g., to account for cross-contributions).

FIG. 4C illustrates an example of an SFN communication scheme 402 that supports antenna subset selection for m-TRP uplink transmissions in accordance with one or more aspects of the present disclosure. In accordance with the SFN communication scheme 402, a UE 115 may transmit a set of layers 415 using one or more resource indicators 420 (e.g., resource indicator 420-a and resource indicator 420-b, where each resource indicator 420 may be an example of a sounding reference signal (SRS) resource indicator (SRI)), using a set of PUSCH ports 425, and using one or more panels 430 (e.g., panel 430-a and panel 430-b). In some cases, the UE 115 may transmit one or more layers of the set of layers 415 using the panel 430-a and one or more layers of the set of layers 415 using the panel 430-b (e.g., with different transmit beams or precoders). In any case, the UE 115 may transmit, to the network entity 105 (e.g., including the TRP 405-a and the TRP 405-b), the set of layers using the one or more panels 430 via one or more wireless communication links 440 (e.g., one or more beams, one or more channels).

FIG. 4D illustrates an example of a joint reception communication scheme 403 that supports antenna subset selection for m-TRP uplink transmissions in accordance with one or more aspects of the present disclosure. In accordance with the joint reception communication scheme 403, a UE 115 may process a common set of layers 445. That is, a set of layers 415 may be an input to a precoder 450. The precoder 450 may output to one or more PUSCH ports 425 into a panel 430 (e.g., an antenna array) of the UE 115. The UE 115 may transmit the set of layers 415 using the panel 430 via one or more wireless communication links 440. The common set of layers 445 may be intended for both the TRP 405-a and the TRP 405-b. Accordingly, each TRP 405 may jointly use reception of direct contributions and cross contributions.

In some implementations, by supporting selection of UE transmit antennas and receive antenna port subsets for multiple TRPs 405 (e.g., the TRP 405-a, the TRP 405-b), the techniques described herein may be used to improve spectral efficiency and enable energy savings for devices within a wireless communications system that uses the communication schemes described herein (e.g., the TDM communication scheme 400, the SDM communication scheme 401, the SFN communication scheme 402, and the joint reception communication scheme 403). These techniques may also improve energy efficiency at a UE 115 and at one or more network entities 105 associated with the multiple TRPs 405 (e.g., by providing a UE with information for reliable antenna selection, which may reduce wasted power when communicating with multiple TRPs). Further, the techniques described herein may allow the UE 115 to select reliable (e.g., suitable) antenna port subsets for communicating with each TRP 405 according to an m-TRP scheme (e.g., by selecting antennas based on downlink information indicating a communication scheme used for communication with the TRP).

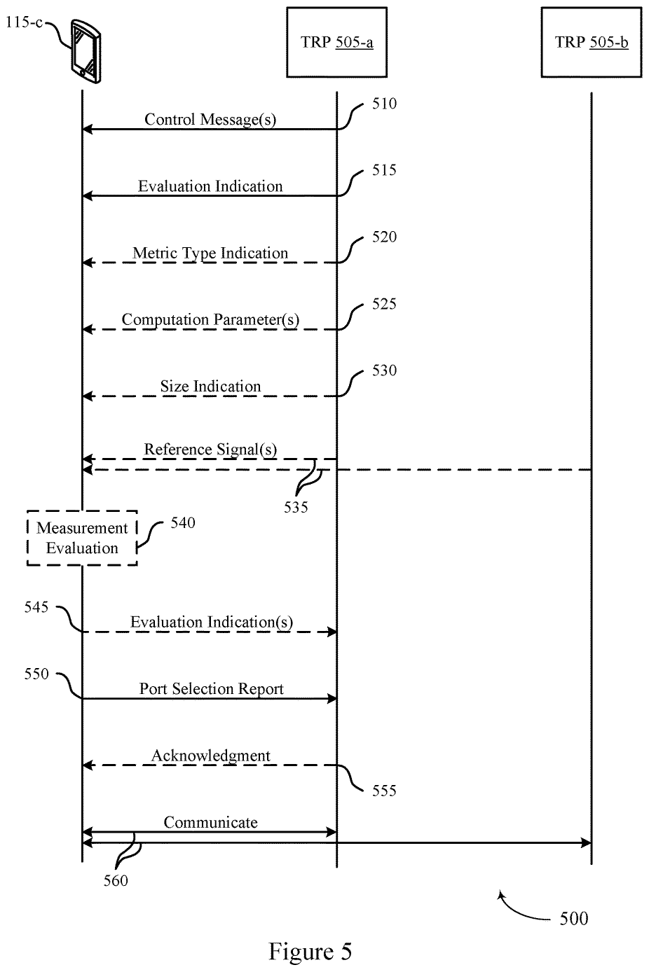

FIG. 5 shows an example of a process flow 500 that supports antenna subset selection for m-TRP uplink transmissions in accordance with one or more aspects of the present disclosure. The process flow 500 includes a UE 115-c, a TRP 505-a, and a TRP 505-b, which may be examples of the corresponding devices as described with respect to FIGS. 1-4D. In the following description of the process flow 500, the operations between the UE 115-c, the TRP 505-a, and the TRP 505-b may be performed in a different order than the example order shown. Some operations may also be omitted from the process flow 500, and other operations may be added to the process flow 500. Further, although some operations or signaling may be shown to occur at different times for discussion purposes, these operations may actually occur at the same time. In some cases, although some signaling may be illustrated as being received by the UE 115-c from one TRP (e.g., the TRP 505-a), such signaling may also be received by one or more other TRPs, from a network entity 105, or from a combination thereof. In some examples, signaling transmitted by the UE 115-c may be obtained (e.g., received) by one or more network entities 105 (e.g., via one or more TRPs 505 associated with the one or more network entities 105, such as the TRP 505-a). Similarly, signaling described to be received by the UE 115-c may be output (e.g., transmitted) by one or more network entities 105 (e.g., via one or more TRPs 505 associated with the one or more network entities 105, such as the TRP 505-a).

At 510, the UE 115-c may receive one or more control messages that indicate a set of CSI report configurations. Each CSI report configuration of the set of CSI report configurations may include one or more sub-configurations. In some cases, each CSI report configuration of the set may be associated with (e.g., correspond to) a respective TRP 505 of a set of TRPs 505 (e.g., including the TRP 505-a, the TRP 505-b, one or more other TRPs 505, or any combination thereof). For example, each CSI report configuration may be configured to enable the UE 115-c to select one or more antenna ports for communication with a respective TRP 505. In some examples, the one or more sub-configurations may be associated with a set of one or more reception antennas of a respective TRP 505 of the set of TRPs 505. For example, the one or more sub-configurations may identify one or more parameters associated with the set of one or more reception antennas for the respective TRPs.

At 515, the UE 115-c may receive an indication to perform an evaluation of one or more measurements associated with one or more downlink reference signals (e.g., CSI-RSs) in accordance with one or more combinations (e.g., tuples) of sub-configurations. Each combination of the one or more combinations (e.g., each tuple of the one or more tuples) may include a set of sub-configurations. Each sub-configuration of the set of sub-configurations may be from a respective CSI report configuration. For example, each respective CSI report configuration (associated with each TRP 505) may include one or more sub-configurations that are each included in a combination of sub-configurations for a measurement evaluation by the UE 115-c. In some cases, each CSI report configuration of the set of CSI report configurations may be associated with a CSI resource configuration that indicates multiple downlink reference signal resources associated with each respective TRP 505 of the set of TRPs 505.

At 520, the UE 115-c may receive a metric type indication that indicates a communication scheme usable for communications with the set of TRPs 505. The communication scheme may be a joint reception scheme, an SDM scheme, an SFN scheme, a TDM scheme, or any combination thereof. In some cases, the UE 115-c may select the one or more antenna ports in accordance with the communication scheme (e.g., selecting antenna ports for each TRP 505 based on a communication scheme used to communicate with each TRP 505).

In some examples, the metric type indication may indicate a communication scheme such as an energy efficiency scheme (e.g., an energy conservation scheme, an energy consumption reduction scheme). The energy efficiency scheme may implicitly or explicitly indicate one or more energy efficiency metrics to target improved energy efficiency at the UE 115-c and one or more network entities 105 that include the set of TRPs 505. The UE 115-c may select the one or more antenna ports in accordance with the energy efficiency scheme. As described herein, the one or more energy efficiency metrics (e.g., signaled by one or more network entities 105) may include power consumption limits per antenna port, duty cycle constraints for TRP activation states, and transmission power efficiency thresholds that balance performance with energy consumption. Additionally, or alternatively, the UE 115-c may receive energy efficiency metrics such as sleep mode indicators for inactive antenna ports (as well as, relative energy consumption reduction due to deactivation of TRP ports at one or more TRPs) and energy-aware rank adaptation parameters that reduce a quantity of active layers (e.g., if energy savings are prioritized over peak throughput).

At 525, the UE 115-c may receive an indication of one or more parameters for each TRP 505 of the set of TRPs 505 (e.g., a respective set of one or more parameters associated with each TRP 505 of the set of TRPs 505). Each indication of one or more parameters may be associated with computation of an uplink spectral efficiency associated with each TRP 505 of the set of TRPs 505. For example, the UE 115-c may compute (e.g., calculate, generate) an uplink spectral efficiency value for each TRP 505 of the set of TRPs 505 using the one or more parameters associated with each TRP 505. In some examples, each set of one or more parameters (corresponding to each TRP 505) may include a quantization distortion indication, a covariance matrix for uplink noise and interference associated with a respective TRP (e.g., the TRP associated with the set of one or more parameters), one or more calibration parameters, or any combination thereof. At 530, the UE 115-c may receive a size indication that indicates a respective quantity of sub-configurations within each combination of the one or more combinations (e.g., a size of each of the one or more combinations).

At 535, the UE 115-c may receive (e.g., via one or more antenna elements of the UE 115-c) the one or more downlink reference signals (e.g., CSI-RSs) in accordance with the set of CSI report configurations. In some cases, the UE 115-c may receive a respective downlink reference signal from each TRP 505 of the set of TRPs 505. For example, the UE 115-c may receive a first reference signal from the TRP 505-a and a second reference signal from the TRP 505-b.

At 540, the UE 115-c may perform the evaluation of the one or more measurements associated with the downlink reference signals. In some examples, the UE 115-c may perform the evaluation based on the one or more parameters for each TRP (e.g., a respective evaluation for each TRP). In some cases, the evaluation of the one or more measurements may be based on one or more respective measurements of the one or more downlink reference signals. In some implementations, the UE 115-c may select the one or more antenna ports based on a channel reciprocity associated with the one or more downlink reference signals (e.g., selecting antenna ports for uplink communication based on downlink signal measurements).

At 545, the UE 115-c may transmit a message that includes one or more indications that result from the evaluation of the one or more measurements (and resulting from the selection of the one or more antennas). For example, the UE 115-c may transmit a first indication of a quantity of ports (e.g., antenna ports) selected for each combination of the one or more combinations. In some examples, the UE 115-c may transmit a second indication of one or more metric values associated with the one or more downlink reference signals in accordance with the evaluation of the one or more measurements. In some cases, the UE 115-c may transmit a third indication of a respective metric value associated with each combination of the one or more combinations. Additionally, or alternatively, the UE 115-c may transmit a fourth indication of a quantity of ports (e.g., antenna ports) selected for each combination of a threshold quantity of combinations and a respective metric value associated with each combination of the threshold quantity of combinations.

At 550, the UE 115-c may transmit a report that indicates the one or more antenna ports selected by the UE 115-c (e.g., in accordance with the evaluation). In some cases, the UE 115-c may transmit the report via one or more UCI messages, via one or more MAC-CE messages, via one or more messages triggered by one or more events, or any combination thereof. At 555, in some cases, the UE 115-c may receive an acknowledgment message in response to the report. The acknowledgment message may indicate a selected combination of the one or more combinations of sub-configurations.

At 560, the UE 115-c may communicate with the set of TRPs 505 via the one or more antenna ports selected by the UE 115-c. In some cases, the UE 115-c may select the one or more antenna ports in accordance with the evaluation of the one or more measurements. In some examples, the UE 115-c may communicate with each TRP of the plurality of TRPs via a respective set of one or more antenna ports of a set of antenna ports. The UE 115-c may select each respective set of one or more antenna ports in accordance with the evaluation of the one or more measurements (e.g., a respective evaluation of the one or more measurements corresponding to each TRP or corresponding to each set of multiple TRPs).

In some implementations, by supporting selection of UE transmit antennas and receive antenna port subsets for multiple TRPs 505 (e.g., the TRP 505-a, the TRP 505-b), the techniques described herein may be used to improve spectral efficiency for devices within a wireless communications system supported by the process flow 500 (e.g., by selecting more reliable antenna ports for communication with each TRP on a per-TRP basis, which may allow for improved communication using a narrower bandwidth). These techniques may also improve energy efficiency at the UE 115-c and at one or more network entities 105 associated with the multiple TRPs 505 (e.g., by selecting more reliable antenna ports for communication with each TRP on a per-TRP basis, which may reduce wasted energy for m-TRP communication). Further, the techniques described herein may allow the UE 115-c to select reliable (e.g., suitable) antenna port subsets for communicating with each TRP 505 according to an m-TRP scheme (e.g., based on TRP-specific configurations and positioning information).

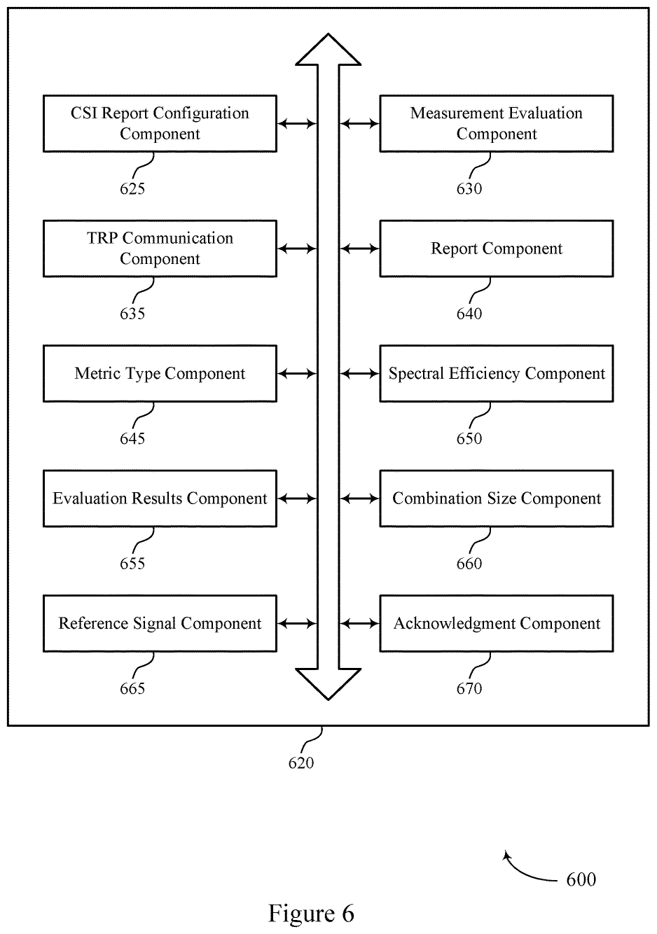

FIG. 6 shows an example of a processing system 620 that supports antenna subset selection for m-TRP uplink transmissions in accordance with one or more aspects of the present disclosure. A processing system 620 may be an example of a processing system 140 (such as of a UE 115) and may include a CSI report configuration component 625, a measurement evaluation component 630, an TRP communication component 635, a report component 640, a metric type component 645, a spectral efficiency component 650, an evaluation results component 655, a combination size component 660, a reference signal component 665, an acknowledgment component 670, or any combination thereof. A processing system 620, or various component thereof, may be an example of means for performing (such as a means for causing a UE 115 to perform) various techniques described herein.

The CSI report configuration component 625 may be configured to cause the UE 115 to receive one or more control messages that indicate a set of multiple CSI report configurations, where each CSI report configuration includes one or more sub-configurations, and where each CSI report configuration of the set of multiple CSI report configurations is associated with a respective TRP of a set of multiple TRPs. The measurement evaluation component 630 may be configured to cause the UE 115 to receive an indication to perform an evaluation of one or more measurements associated with one or more downlink reference signals in accordance with one or more combinations of sub-configurations, where each combination of the one or more combinations includes a set of multiple sub-configurations, and where each sub-configuration of the set of multiple sub-configurations is from a respective CSI report configuration. The TRP communication component 635 may be configured to cause the UE 115 to communicate with the set of multiple TRPs via one or more antenna ports selected by the UE, the one or more antenna ports selected in accordance with the evaluation of the one or more measurements.

In some examples, the report component 640 may be configured to cause the UE 115 to transmit a report that indicates the one or more antenna ports selected by the UE.

In some examples, the acknowledgment component 670 may be configured to cause the UE 115 to receive, in response to the report, an acknowledgment message that indicates a selected combination of the one or more combinations of sub-configurations.

In some examples, to support transmitting the report, the report component 640 may be configured to cause the UE 115 to transmit the report via one or more UCI messages, via one or more MAC-CE messages, via one or more messages triggered by one or more events, or any combination thereof.

In some examples, the metric type component 645 may be configured to cause the UE 115 to receive a metric type indication that indicates a communication scheme usable for communications with the set of multiple TRPs, the communication scheme including a joint reception scheme, an SDM scheme, an SFN scheme, a TDM scheme, or any combination thereof, where the one or more antenna ports are selected in accordance with the communication scheme.

In some examples, the spectral efficiency component 650 may be configured to cause the UE 115 to receive, for each TRP of the set of multiple TRPs, an indication of one or more parameters associated with computation of an uplink spectral efficiency associated with each TRP of the set of multiple TRPs, where the evaluation is based on the one or more parameters for each TRP.

In some examples, the one or more parameters include a quantization distortion indication, a covariance matrix for uplink noise and interference associated with a respective TRP, one or more calibration parameters, or any combination thereof.

In some examples, the evaluation results component 655 may be configured to cause the UE 115 to transmit a message including a first indication of a quantity of ports selected for each combination of the one or more combinations, a second indication of one or more metric values associated with the one or more downlink reference signals in accordance with the evaluation of the one or more measurements, a third indication of a respective metric value associated with each combination of the one or more combinations, or any combination thereof.

In some examples, the message further includes a fourth indication of a quantity of ports selected for each combination of a threshold quantity of combinations and a respective metric value associated with each combination of the threshold quantity of combinations.

In some examples, the combination size component 660 may be configured to cause the UE 115 to receive a size indication that indicates a respective quantity of sub-configurations within each combination of the one or more combinations.

In some examples, to support communicating with the set of multiple TRPs, the TRP communication component 635 may be configured to cause the UE 115 to communicate with each TRP of the set of multiple TRPs via a respective set of one or more antenna ports of a set of multiple antenna ports, each respective set of one or more antenna ports selected by the UE in accordance with the evaluation of the one or more measurements.

In some examples, each CSI report configuration of the set of multiple CSI report configurations is associated with a CSI resource configuration that indicates multiple downlink reference signal resources associated with each respective TRP of the set of multiple TRPs.

In some examples, the one or more antenna ports are selected based on a channel reciprocity associated with the one or more downlink reference signals.

In some examples, the reference signal component 665 may be configured to cause the UE 115 to receive the one or more downlink reference signals in accordance with the set of multiple CSI report configurations, where the evaluation of the one or more measurements is based on one or more respective measurements of the one or more downlink reference signals.

In some examples, the one or more downlink reference signals include one or more CSI-RSs.

In some examples, the one or more sub-configurations are associated with a set of one or more reception antennas of a respective TRP of the set of multiple TRPs.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for antenna subset selection for m-TRP uplink transmissions, which may result in reduced power consumption, more efficient utilization of communication resources, improved spectral efficiency, improved energy efficiency, and more reliable selection of antenna ports for TRP communication.

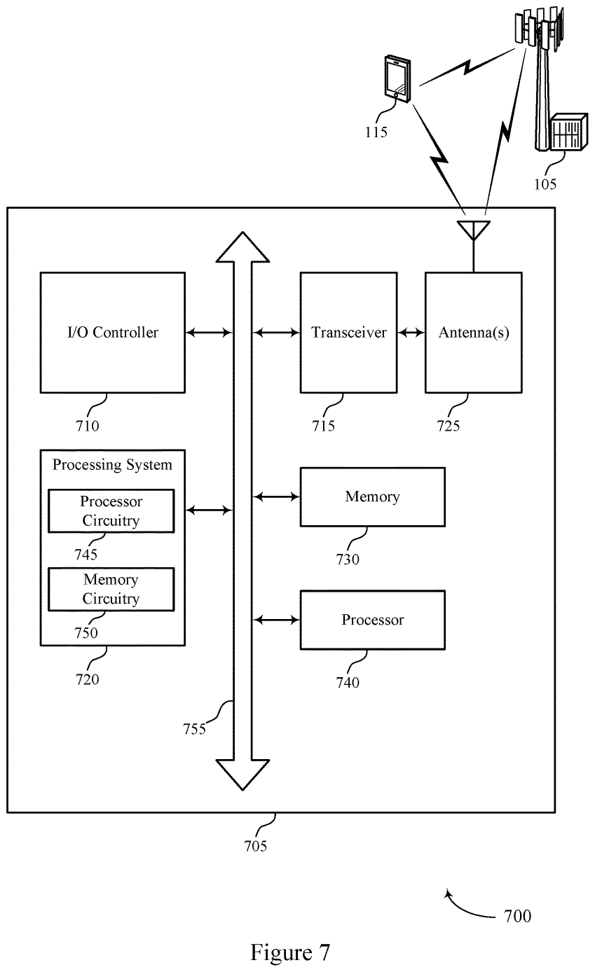

FIG. 7 shows an example of a system 700 including a device 705 that supports antenna subset selection for m-TRP uplink transmissions in accordance with one or more aspects of the present disclosure. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 600. For example, the processing system 720 may include processor circuitry 745 and memory circuitry 750 that stores code, and may be configured to cause the device 705 to perform operations that support antenna subset selection for m-TRP uplink transmissions. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for antenna subset selection for m-TRP uplink transmissions, which may result in improved communication reliability, reduced latency, reduced power consumption, more efficient utilization of communication resources, improved spectral efficiency, improved energy efficiency, more reliable selection of antenna ports for TRP communication, improved coordination between devices, and improved utilization of processing capability.

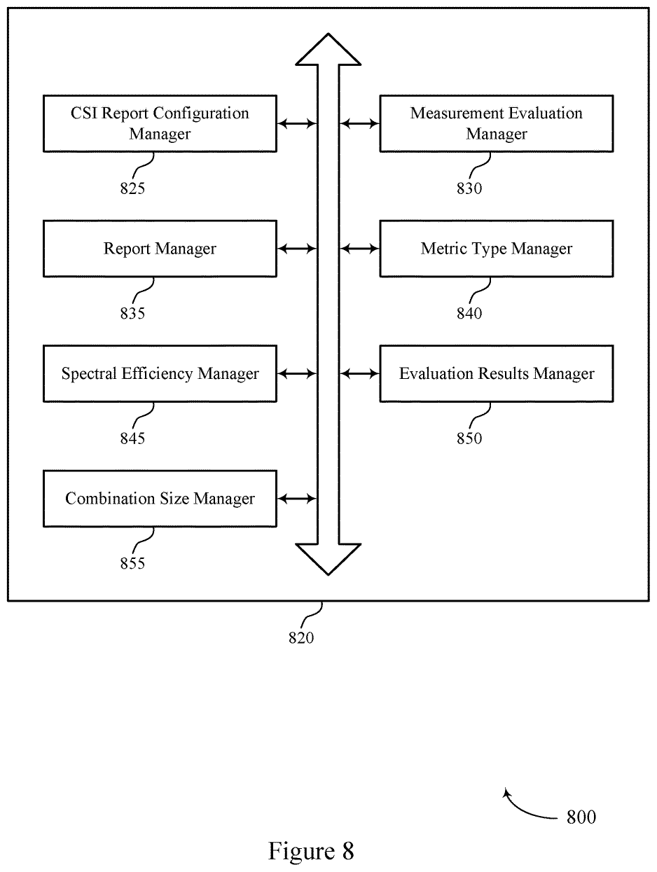

FIG. 8 shows an example of a processing system 820 that supports antenna subset selection for m-TRP uplink transmissions in accordance with one or more aspects of the present disclosure. A processing system 820 may be an example of a processing system 145 (such as network entity 105) and may include a CSI report configuration manager 825, a measurement evaluation manager 830, a report manager 835, a metric type manager 840, a spectral efficiency manager 845, an evaluation results manager 850, a combination size manager 855, or any combination thereof. A processing system 820, or various component thereof, may be an example of means for performing (such as a means for causing a network entity 105 to perform) various techniques described herein.

The CSI report configuration manager 825 may be configured to cause the network entity 105 to output one or more control messages that indicate a set of multiple CSI report configurations, each CSI report configuration includes one or more sub-configurations, where each CSI report configuration of the set of multiple CSI report configurations is associated with a respective TRP of a set of multiple TRPs. The measurement evaluation manager 830 may be configured to cause the network entity 105 to output an indication to perform an evaluation of one or more measurements associated with one or more downlink reference signals in accordance with one or more combinations of sub-configurations, where each combination of the one or more combinations includes a set of multiple sub-configurations, and where each sub-configuration of each set of multiple sub-configurations is from a respective CSI report configuration. The report manager 835 may be configured to cause the network entity 105 to obtain a report that indicates one or more antenna ports in accordance with the indication to perform the evaluation.

In some examples, the metric type manager 840 may be configured to cause the network entity 105 to output a metric type indication that indicates a communication scheme usable for communications with the set of multiple TRPs, the communication scheme including a joint reception scheme, an SDM scheme, an SFN scheme, a TDM scheme, or any combination thereof, where the one or more antenna ports are selected in accordance with the communication scheme.

In some examples, the spectral efficiency manager 845 may be configured to cause the network entity 105 to output an indication of one or more parameters associated with computation of an uplink spectral efficiency associated with each TRP of the set of multiple TRPs.

In some examples, the evaluation results manager 850 may be configured to cause the network entity 105 to obtain a message including a first indication of a quantity of ports selected for each combination of the one or more combinations, a second indication of one or more metric values associated with the one or more downlink reference signals in accordance with the evaluation of the one or more measurements, a third indication of a respective metric value associated with each combination of the one or more combinations, or any combination thereof.

In some examples, the combination size manager 855 may be configured to cause the network entity 105 to output a size indication that indicates a respective quantity of sub-configurations within each combination of the one or more combinations.

A processing system 820 may include or be an example of one or more chips, SoCs, chipsets, packages, components, or devices that individually or collectively constitute or include a processing system. A processing system 820 may interface with other components of a network entity 105. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a network entity 105). Operations described herein with reference to the processing system 820, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 820 for operation in a processing system 820 as described herein, the processing system 820 may support techniques for antenna subset selection for m-TRP uplink transmissions, which may result in reduced power consumption, more efficient utilization of communication resources, improved spectral efficiency, improved energy efficiency, and more reliable selection of antenna ports for TRP communication.

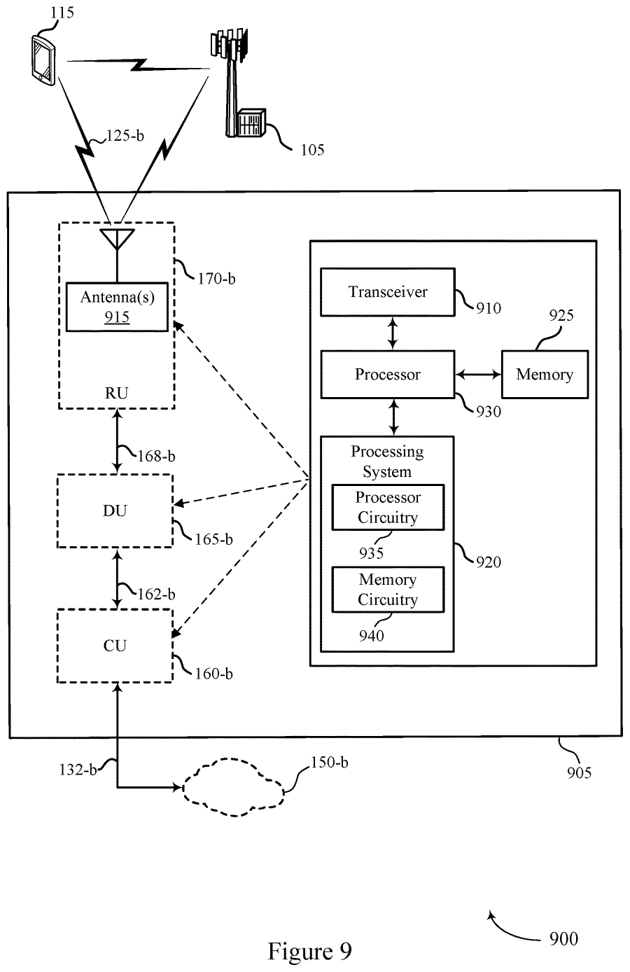

FIG. 9 shows an example of a system 900 including a device 905 that supports antenna subset selection for m-TRP uplink transmissions in accordance with one or more aspects of the present disclosure. The device 905 may communicate (such as via one or more wired interfaces or one or more wireless interfaces) with other network devices or network equipment such as a core network 150-b, other network entities 105, UEs 115, or any combination thereof. The device 905 may include components for transmitting and receiving communication, which may include a processing system 920, a transceiver 910, antenna(s) 915, a memory 925, and a processor 930. Components of the device 905 may be coupled (such as operatively, communicatively, functionally, electronically, electrically, in electronic communication) via one or more interfaces.

The transceiver 910 may communicate bi-directionally with another transceiver via wired or wireless links, and may support transmission operations, reception operations, or both, as described herein. The transceiver 910 may include a modem to modulate and demodulate signals, to provide the modulated signals for transmission (such as via antenna(s) 915, via a wired interface), and to demodulate received signals (such as received via antenna(s) 915, received via a wired interface). The transceiver 910 may be operable to support communication via one or more communication links (such as a communication link 125-b, a backhaul link 132-b, a midhaul link 162-b, fronthaul link 168-b).

The processor 930 may be a general-purpose processing component that supports various operations (such as applications) of the device 905. The memory 925 may be a general-purpose storage component that stores code executable by the processor 930. Such code may include instructions that, when executed by the processor 930, cause the device 905 to perform various functions (such as to support an application of the device 905).

For examples in which the device 905 is a network entity 105 in a disaggregated architecture, one or more components of the device 905 may be located at one or more of a CU 160-b, a DU 165-b, or an RU 170-b, one or more of which may include aspects of the processing system 920, the processor 930, the memory 925, or the transceiver 910. Functions of the device 905 may be performed at different components or an operation may be divided between different components (such as different functions being supported by aspects of the CU 160-b, the DU 165-b, or the RU 170-b, the transceiver 910, the processor 930, the memory 925, the processing system 920, or any combination thereof). For example, the processing system 920 may be a component of one or more of the CU 160-b, the DU 165-b, or the RU 170-b. In some examples, interfaces between components of device 905 (such as CU 160-b, DU 165-b, RU 170-b) may support communication at a protocol layer or between protocol layers of a protocol stack.

In some examples, the processing system 920 may manage aspects of communication with the core network 150-b (such as via a backhaul link 132). For example, the processing system 920 may manage the transfer of data communication for UEs 115 with a gateway of the core network 150-b. In some examples, the processing system 920 may manage communication with one or more other network entities 105 and may include a controller or scheduler for controlling communication with UEs 115 (such as in cooperation with the one or more other network entities 105). In some examples, the processing system 920 may support an interface (such as X2 interface, Xn interface) to provide communication between network entities 105.

The processing system 920 may be an example of a processing system 145 or a processing system 800. For example, the processing system 920 may include processor circuitry 935 and memory circuitry 940 that stores code, and the processing system 920 may be configured to cause the device 905 to perform operations that support antenna subset selection for m-TRP uplink transmissions. Although the processing system 920 is illustrated as a separate component, which may involve a separate chip, chipset, or other module, in some implementations, one or more functions described with reference to the processing system 920 may be supported by or performed by a transceiver 910, antenna(s) 915, a processor 930, memory 925, or any combination thereof, such that a processing system 920 may include one or more of a transceiver 910, antenna(s) 915, a processor 930, memory 925, or any combination thereof. Further, processor circuitry 935 and memory circuitry 940 each may be implemented at the device 905 in accordance with an aggregated architecture, or the processor circuitry 935 and the memory circuitry 940 may be implemented at one or more of a CU 160-b, a DU 165-b, or an RU 170-b in accordance with a disaggregated architecture.

By including or configuring the processing system 920 for operation in the device 905 as described herein, may support techniques for antenna subset selection for m-TRP uplink transmissions, which may result in improved communication reliability, reduced latency, reduced power consumption, more efficient utilization of communication resources, improved spectral efficiency, improved energy efficiency, more reliable selection of antenna ports for TRP communication, improved coordination between devices, and improved utilization of processing capability.

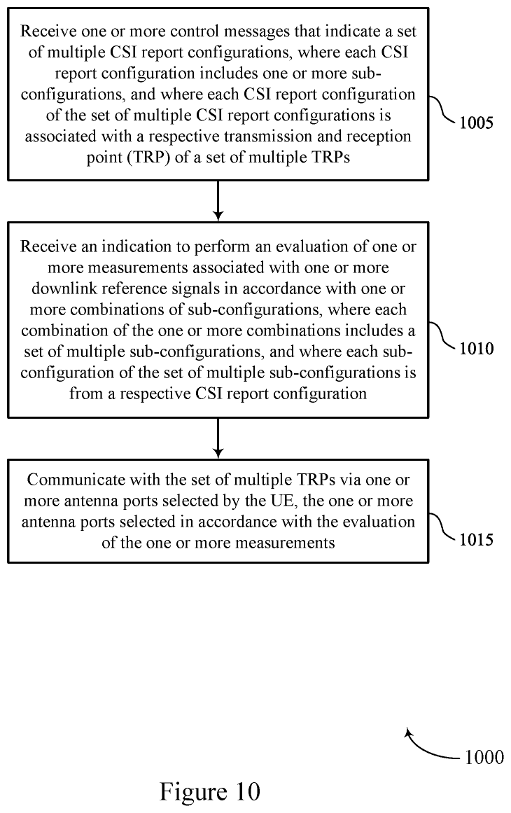

FIG. 10 shows an example of a method 1000 that supports antenna subset selection for m-TRP uplink transmissions in accordance with one or more aspects of the present disclosure. Operations of the method 1000 may be performed by a UE or its components (such as using a processing system configured to cause the UE 115 to perform one or more of the operations) as described herein.

At 1005, the method may include receiving one or more control messages that indicate a set of multiple CSI report configurations, where each CSI report configuration includes one or more sub-configurations, and where each CSI report configuration of the set of multiple CSI report configurations is associated with a respective TRP of a set of multiple TRPs. In some examples, aspects of the operations of 1005 may be performed by a CSI report configuration component 625.

At 1010, the method may include receiving an indication to perform an evaluation of one or more measurements associated with one or more downlink reference signals in accordance with one or more combinations of sub-configurations, where each combination of the one or more combinations includes a set of multiple sub-configurations, and where each sub-configuration of the set of multiple sub-configurations is from a respective CSI report configuration. In some examples, aspects of the operations of 1010 may be performed by a measurement evaluation component 630.

At 1015, the method may include communicating with the set of multiple TRPs via one or more antenna ports selected by the UE, the one or more antenna ports selected in accordance with the evaluation of the one or more measurements. In some examples, aspects of the operations of 1015 may be performed by an TRP communication component 635.

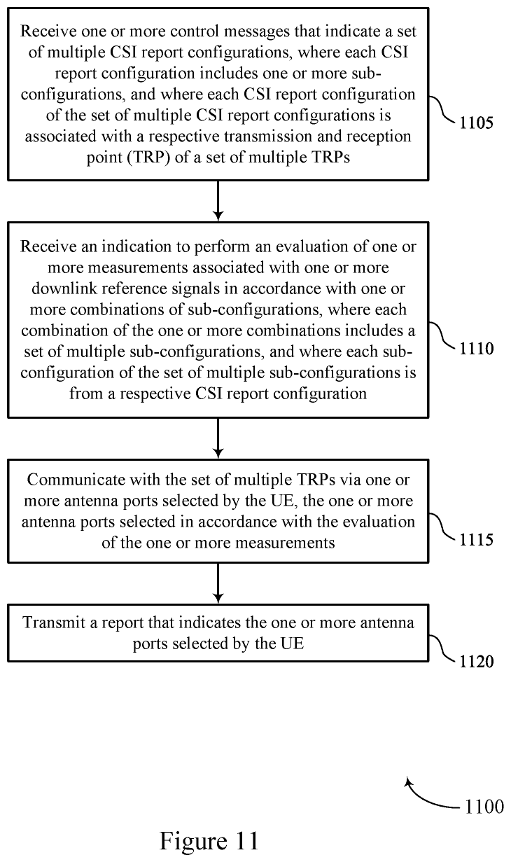

FIG. 11 shows an example of a method 1100 that supports antenna subset selection for m-TRP uplink transmissions in accordance with one or more aspects of the present disclosure. Operations of the method 1100 may be performed by a UE or its components (such as using a processing system configured to cause the UE 115 to perform one or more of the operations) as described herein.

At 1105, the method may include receiving one or more control messages that indicate a set of multiple CSI report configurations, where each CSI report configuration includes one or more sub-configurations, and where each CSI report configuration of the set of multiple CSI report configurations is associated with a respective TRP of a set of multiple TRPs. In some examples, aspects of the operations of 1105 may be performed by a CSI report configuration component 625.

At 1110, the method may include receiving an indication to perform an evaluation of one or more measurements associated with one or more downlink reference signals in accordance with one or more combinations of sub-configurations, where each combination of the one or more combinations includes a set of multiple sub-configurations, and where each sub-configuration of the set of multiple sub-configurations is from a respective CSI report configuration. In some examples, aspects of the operations of 1110 may be performed by a measurement evaluation component 630.

At 1115, the method may include communicating with the set of multiple TRPs via one or more antenna ports selected by the UE, the one or more antenna ports selected in accordance with the evaluation of the one or more measurements. In some examples, aspects of the operations of 1115 may be performed by an TRP communication component 635.

At 1120, the method may include transmitting a report that indicates the one or more antenna ports selected by the UE. In some examples, aspects of the operations of 1120 may be performed by a report component 640.

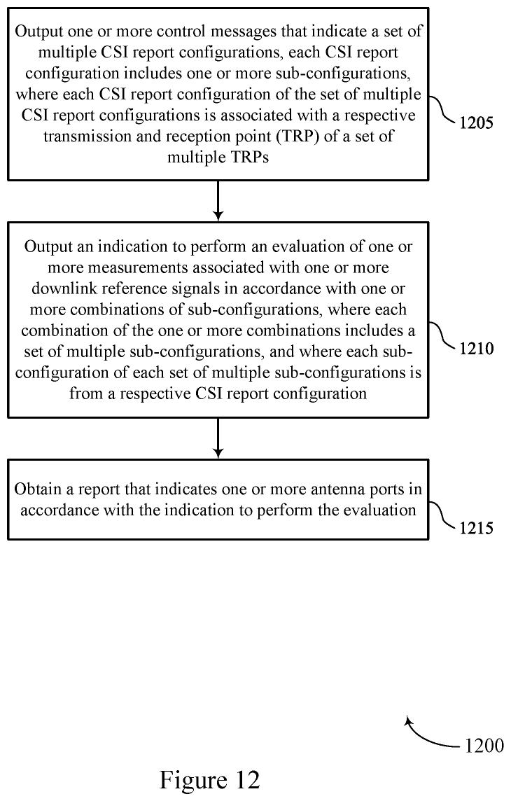

FIG. 12 shows an example of a method 1200 that supports antenna subset selection for m-TRP uplink transmissions in accordance with one or more aspects of the present disclosure. Operations of the method 1200 may be performed by a network entity 105 or its components (such as using a processing system configured to cause the network entity to perform one or more operations) as described herein.

At 1205, the method may include outputting one or more control messages that indicate a set of multiple CSI report configurations, each CSI report configuration includes one or more sub-configurations, where each CSI report configuration of the set of multiple CSI report configurations is associated with a respective TRP of a set of multiple TRPs. In some examples, aspects of the operations of 1205 may be performed by a CSI report configuration manager 825.

At 1210, the method may include outputting an indication to perform an evaluation of one or more measurements associated with one or more downlink reference signals in accordance with one or more combinations of sub-configurations, where each combination of the one or more combinations includes a set of multiple sub-configurations, and where each sub-configuration of each set of multiple sub-configurations is from a respective CSI report configuration. In some examples, aspects of the operations of 1210 may be performed by a measurement evaluation manager 830.

At 1215, the method may include obtaining a report that indicates one or more antenna ports in accordance with the indication to perform the evaluation. In some examples, aspects of the operations of 1215 may be performed by a report manager 835.

Implementation examples are described in the following numbered clauses:

Aspect 1: A method for wireless communication at a UE, comprising: receiving one or more control messages that indicate a plurality of CSI report configurations, wherein each CSI report configuration comprises one or more sub-configurations, and wherein each CSI report configuration of the plurality of CSI report configurations is associated with a respective TRP of a plurality of TRPs; receiving an indication to perform an evaluation of one or more measurements associated with one or more downlink reference signals in accordance with one or more combinations of sub-configurations, wherein each combination of the one or more combinations includes a plurality of sub-configurations, and wherein each sub-configuration of the plurality of sub-configurations is from a respective CSI report configuration; and communicating with the plurality of TRPs via one or more antenna ports selected by the UE, the one or more antenna ports selected in accordance with the evaluation of the one or more measurements.

Aspect 2: The method of aspect 1, further comprising: transmitting a report that indicates the one or more antenna ports selected by the UE.

Aspect 3: The method of aspect 2, further comprising: receiving, in response to the report, an acknowledgment message that indicates a selected combination of the one or more combinations of sub-configurations.

Aspect 4: The method of any of aspects 2 through 3, wherein transmitting the report comprises: transmitting the report via one or more UCI messages, via one or more MAC-CE messages, via one or more messages triggered by one or more events, or any combination thereof.

Aspect 5: The method of any of aspects 1 through 4, further comprising: receiving a metric type indication that indicates a communication scheme usable for communications with the plurality of TRPs, the communication scheme comprising a joint reception scheme, an SDM scheme, an SFN scheme, a TDM scheme, or any combination thereof, wherein the one or more antenna ports are selected in accordance with the communication scheme.

Aspect 6: The method of any of aspects 1 through 5, further comprising: receiving a metric type indication that indicates an energy efficiency scheme usable for communications with the plurality of TRPs, wherein the energy efficiency scheme indicates one or more energy efficiency metrics, and wherein the one or more antenna ports are selected in accordance with the energy efficiency scheme.

Aspect 7: The method of any of aspects 1 through 6, further comprising: receiving a metric type indication that indicates a communication scheme usable for communications with the plurality of TRPs.

Aspect 8: The method of aspect 7, wherein the communication scheme comprises a joint reception scheme, an SDM scheme, an SFN scheme, a TDM scheme, or any combination thereof.

Aspect 9: The method of any of aspects 1 through 8, wherein the one or more antenna ports are selected in accordance with a communication scheme.

Aspect 10: The method of any of aspects 1 through 9, further comprising: receiving, for each TRP of the plurality of TRPs, an indication of one or more parameters associated with computation of an uplink spectral efficiency associated with each TRP of the plurality of TRPs, wherein the evaluation is based at least in part on the one or more parameters for each TRP.

Aspect 11: The method of aspect 10, wherein the one or more parameters comprise a quantization distortion indication, a covariance matrix for uplink noise and interference associated with a respective TRP, one or more calibration parameters, or any combination thereof.

Aspect 12: The method of any of aspects 1 through 11, further comprising: transmitting a message comprising a first indication of a quantity of ports selected for each combination of the one or more combinations, a second indication of one or more metric values associated with the one or more downlink reference signals in accordance with the evaluation of the one or more measurements, a third indication of a respective metric value associated with each combination of the one or more combinations, or any combination thereof.

Aspect 13: The method of aspect 12, wherein the message further comprises a fourth indication of a quantity of ports selected for each combination of a threshold quantity of combinations and a respective metric value associated with each combination of the threshold quantity of combinations.

Aspect 14: The method of any of aspects 1 through 13, further comprising: receiving a size indication that indicates a respective quantity of sub-configurations within each combination of the one or more combinations.

Aspect 15: The method of any of aspects 1 through 14, wherein communicating with the plurality of TRPs comprises: communicating with each TRP of the plurality of TRPs via a respective set of one or more antenna ports of a plurality of antenna ports, each respective set of one or more antenna ports selected by the UE in accordance with the evaluation of the one or more measurements.

Aspect 16: The method of any of aspects 1 through 15, wherein each CSI report configuration of the plurality of CSI report configurations is associated with a CSI resource configuration that indicates multiple downlink reference signal resources associated with each respective TRP of the plurality of TRPs.

Aspect 17: The method of any of aspects 1 through 16, wherein the one or more antenna ports are selected based at least in part on a channel reciprocity associated with the one or more downlink reference signals.

Aspect 18: The method of any of aspects 1 through 17, further comprising: receiving the one or more downlink reference signals in accordance with the plurality of CSI report configurations, wherein the evaluation of the one or more measurements is based at least in part on one or more respective measurements of the one or more downlink reference signals.

Aspect 19: The method of any of aspects 1 through 18, wherein the one or more downlink reference signals comprise one or more CSI-RSs.

Aspect 20: The method of any of aspects 1 through 19, wherein the one or more sub-configurations are associated with a set of one or more reception antennas of a respective TRP of the plurality of TRPs.

Aspect 21: A method for wireless communication at a network entity, comprising: outputting one or more control messages that indicate a plurality of CSI report configurations, each CSI report configuration comprises one or more sub-configurations, wherein each CSI report configuration of the plurality of CSI report configurations is associated with a respective TRP of a plurality of TRPs; outputting an indication to perform an evaluation of one or more measurements associated with one or more downlink reference signals in accordance with one or more combinations of sub-configurations, wherein each combination of the one or more combinations includes a plurality of sub-configurations, and wherein each sub-configuration of each plurality of sub-configurations is from a respective CSI report configuration; and obtaining a report that indicates one or more antenna ports in accordance with the indication to perform the evaluation.

Aspect 22: The method of aspect 21, further comprising: outputting a metric type indication that indicates a communication scheme usable for communications with the plurality of TRPs, the communication scheme comprising a joint reception scheme, an SDM scheme, an SFN scheme, a TDM scheme, or any combination thereof, wherein the one or more antenna ports are selected in accordance with the communication scheme.

Aspect 23: The method of any of aspects 21 through 22, further comprising: outputting a metric type indication that indicates an energy efficiency scheme usable for communications with the plurality of TRPs, wherein the energy efficiency scheme indicates one or more energy efficiency metrics, and wherein the one or more antenna ports are selected in accordance with the energy efficiency scheme.

Aspect 24: The method of any of aspects 21 through 23, further comprising: outputting a metric type indication that indicates a communication scheme usable for communications with the plurality of TRPs

Aspect 25: The method of aspect 24, wherein the communication scheme comprises a joint reception scheme, an SDM scheme, an SFN scheme, a TDM scheme, or any combination thereof.

Aspect 26: The method of any of aspects 21 through 25, wherein the one or more antenna ports are selected in accordance with a communication scheme.

Aspect 27: The method of any of aspects 21 through 26, further comprising: outputting an indication of one or more parameters associated with computation of an uplink spectral efficiency associated with each TRP of the plurality of TRPs.

Aspect 28: The method of any of aspects 21 through 27, further comprising: obtaining a message comprising a first indication of a quantity of ports selected for each combination of the one or more combinations, a second indication of one or more metric values associated with the one or more downlink reference signals in accordance with the evaluation of the one or more measurements, a third indication of a respective metric value associated with each combination of the one or more combinations, or any combination thereof.

Aspect 29: The method of any of aspects 21 through 28, further comprising: outputting a size indication that indicates a respective quantity of sub-configurations within each combination of the one or more combinations.

Aspect 30: A UE for wireless communication, comprising one or more memories and one or more processors coupled with the one or more memories and configured to cause the UE to receive one or more control messages that indicate a plurality of CSI report configurations, wherein each CSI report configuration comprises one or more sub-configurations, and wherein each CSI report configuration of the plurality of CSI report configurations is associated with a respective TRP of a plurality of TRPs; receive an indication to perform an evaluation of one or more measurements associated with one or more downlink reference signals in accordance with one or more combinations of sub-configurations, wherein each combination of the one or more combinations includes a plurality of sub-configurations, and wherein each sub-configuration of the plurality of sub-configurations is from a respective CSI report configuration; and communicate with the plurality of TRPs via one or more antenna ports selected by the UE, the one or more antenna ports selected in accordance with the evaluation of the one or more measurements.

Aspect 31: The UE of aspect 30, wherein the one or more processors are configured to cause the UE to: transmit a report that indicates the one or more antenna ports selected by the UE.

Aspect 32: The UE of aspect 31, wherein the one or more processors are configured to cause the UE to: receive, in response to the report, an acknowledgment message that indicates a selected combination of the one or more combinations of sub-configurations.

Aspect 33: The UE of any of aspects 30 through 32, wherein transmitting the report comprises: transmit the report via one or more UCI messages, via one or more MAC-CE messages, via one or more messages triggered by one or more events, or any combination thereof.

Aspect 34: The UE of any of aspects 30 through 33, wherein the one or more processors are configured to cause the UE to: receive a metric type indication that indicates a communication scheme usable for communications with the plurality of TRPs, the communication scheme comprising a joint reception scheme, an SDM scheme, an SFN scheme, a TDM scheme, or any combination thereof, wherein the one or more antenna ports are selected in accordance with the communication scheme.

Aspect 35: The UE of any of aspects 30 through 34, wherein the one or more processors are configured to cause the UE to: receive a metric type indication that indicates an energy efficiency scheme usable for communications with the plurality of TRPs, wherein the energy efficiency scheme indicates one or more energy efficiency metrics, and wherein the one or more antenna ports are selected in accordance with the energy efficiency scheme.

Aspect 36: The UE of any of aspects 30 through 35, wherein the one or more processors are configured to cause the UE to: receive a metric type indication that indicates a communication scheme usable for communications with the plurality of TRPs.

Aspect 37: The UE of aspect 36, wherein the communication scheme comprises a joint reception scheme, an SDM scheme, an SFN scheme, a TDM scheme, or any combination thereof.

Aspect 38: The UE of any of aspects 30 through 37, wherein the one or more antenna ports are selected in accordance with a communication scheme.

Aspect 39: The UE of any of aspects 30 through 38, wherein the one or more processors are configured to cause the UE to: receive, for each TRP of the plurality of TRPs, an indication of one or more parameters associated with computation of an uplink spectral efficiency associated with each TRP of the plurality of TRPs, wherein the evaluation is based at least in part on the one or more parameters for each TRP.

Aspect 40: The UE of aspect 39, wherein the one or more parameters comprise a quantization distortion indication, a covariance matrix for uplink noise and interference associated with a respective TRP, one or more calibration parameters, or any combination thereof.

Aspect 41: The UE of any of aspects 30 through 40, wherein the one or more processors are configured to cause the UE to: transmit a message comprising a first indication of a quantity of ports selected for each combination of the one or more combinations, a second indication of one or more metric values associated with the one or more downlink reference signals in accordance with the evaluation of the one or more measurements, a third indication of a respective metric value associated with each combination of the one or more combinations, or any combination thereof.

Aspect 42: The UE of aspect 41, wherein the message further comprises a fourth indication of a quantity of ports selected for each combination of a threshold quantity of combinations and a respective metric value associated with each combination of the threshold quantity of combinations.

Aspect 43: The UE of any of aspects 30 through 42, wherein the one or more processors are configured to cause the UE to: receive a size indication that indicates a respective quantity of sub-configurations within each combination of the one or more combinations.

Aspect 44: The UE of any of aspects 30 through 43, wherein, to communicate with the plurality of TRPs, the one or more processors are configured to cause the UE to: communicate with each TRP of the plurality of TRPs via a respective set of one or more antenna ports of a plurality of antenna ports, each respective set of one or more antenna ports selected by the UE in accordance with the evaluation of the one or more measurements.

Aspect 45: The UE of any of aspects 30 through 44, wherein each CSI report configuration of the plurality of CSI report configurations is associated with a CSI resource configuration that indicates multiple downlink reference signal resources associated with each respective TRP of the plurality of TRPs.

Aspect 46: The UE of any of aspects 30 through 45, wherein the one or more antenna ports are selected based at least in part on a channel reciprocity associated with the one or more downlink reference signals.

Aspect 47: The UE of any of aspects 30 through 46, further comprising: one or more antenna elements, wherein the one or more processors and the one or more antenna elements are configured to cause the UE to: receive the one or more downlink reference signals in accordance with the plurality of CSI report configurations, wherein the evaluation of the one or more measurements is based at least in part on one or more respective measurements of the one or more downlink reference signals.

Aspect 48: The UE of any of aspects 30 through 47, wherein the one or more downlink reference signals comprise one or more CSI-RSs.

Aspect 49: The UE of any of aspects 30 through 48, wherein the one or more sub-configurations are associated with a set of one or more reception antennas of a respective TRP of the plurality of TRPs.

Aspect 50: A UE for wireless communication, comprising at least one means for performing a method of any of aspects 1 through 20.

Aspect 51: A non-transitory computer-readable medium storing code for wireless communication at a UE, the code comprising instructions executable by one or more processors to perform a method of any of aspects 1 through 20.

Aspect 52: A network entity for wireless communication, comprising one or more memories and one or more processors coupled with the one or more memories and configured to cause the network entity to: output one or more control messages that indicate a plurality of CSI report configurations, each CSI report configuration comprises one or more sub-configurations, wherein each CSI report configuration of the plurality of CSI report configurations is associated with a respective TRP of a plurality of TRPs; output an indication to perform an evaluation of one or more measurements associated with one or more downlink reference signals in accordance with one or more combinations of sub-configurations, wherein each combination of the one or more combinations includes a plurality of sub-configurations, and wherein each sub-configuration of each plurality of sub-configurations is from a respective CSI report configuration; and obtain a report that indicates one or more antenna ports in accordance with the indication to perform the evaluation.

Aspect 53: The network entity of aspect 52, wherein the one or more processors are configured to cause the network entity to: output a metric type indication that indicates a communication scheme usable for communications with the plurality of TRPs, the communication scheme comprising a joint reception scheme, an SDM scheme, an SFN scheme, a TDM scheme, or any combination thereof, wherein the one or more antenna ports are selected in accordance with the communication scheme.

Aspect 54: The network entity of aspect 53, wherein the one or more processors are configured to cause the network entity to: output a metric type indication that indicates an energy efficiency scheme usable for communications with the plurality of TRPs, wherein the energy efficiency scheme indicates one or more energy efficiency metrics, and wherein the one or more antenna ports are selected in accordance with the energy efficiency scheme.

Aspect 55: The network entity of any of aspects 52 through 54, wherein the one or more processors are configured to cause the network entity to: output a metric type indication that indicates a communication scheme usable for communications with the plurality of TRPs

Aspect 56: The network entity of aspect 55, wherein the communication scheme comprises a joint reception scheme, an SDM scheme, an SFN scheme, a TDM scheme, or any combination thereof.

Aspect 57: The network entity of any of aspects 52 through 56, wherein the one or more antenna ports are selected in accordance with a communication scheme.

Aspect 58: The network entity of any of aspects 52 through 57, wherein the one or more processors are configured to cause the network entity to: output an indication of one or more parameters associated with computation of an uplink spectral efficiency associated with each TRP of the plurality of TRPs.

Aspect 59: The network entity of any of aspects 52 through 58, wherein the one or more processors are configured to cause the network entity to: obtain a message comprising a first indication of a quantity of ports selected for each combination of the one or more combinations, a second indication of one or more metric values associated with the one or more downlink reference signals in accordance with the evaluation of the one or more measurements, a third indication of a respective metric value associated with each combination of the one or more combinations, or any combination thereof.

Aspect 60: The network entity of any of aspects 52 through 59, wherein the one or more processors are configured to cause the network entity to: output a size indication that indicates a respective quantity of sub-configurations within each combination of the one or more combinations.

Aspect 61: A network entity for wireless communication, comprising at least one means for performing a method of any of aspects 21 through 29.

Aspect 62: A non-transitory computer-readable medium storing code for wireless communication at a network entity, the code comprising instructions executable by one or more processors to perform a method of any of aspects 21 through 29.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
receive one or more control messages that indicate a plurality of channel state information (CSI) report configurations, wherein each CSI report configuration of the plurality of CSI report configurations comprises one or more sub-configurations, and wherein each CSI report configuration of the plurality of CSI report configurations is associated with a respective transmission and reception point (TRP) of a plurality of TRPs;
receive an indication to perform an evaluation of one or more measurements associated with one or more downlink reference signals in accordance with one or more combinations of sub-configurations, wherein each combination of the one or more combinations includes a plurality of sub-configurations, and wherein each sub-configuration of each plurality of sub-configurations is from a respective CSI report configuration; and
communicate with the plurality of TRPs via one or more antenna ports selected by the UE, the one or more antenna ports selected in accordance with the evaluation of the one or more measurements.

2. The apparatus of claim 1, wherein the one or more processors are configured to cause the UE to:
transmit a report that indicates the one or more antenna ports selected by the UE.

3. The apparatus of claim 2, wherein the one or more processors are configured to cause the UE to:
receive, in response to the report, an acknowledgment message that indicates a selected combination of the one or more combinations of sub-configurations.

4. The apparatus of claim 2, wherein, to transmit the report, the one or more processors are configured to cause the UE to:
transmit the report via one or more uplink control information messages, via one or more medium access control-control element messages, via one or more messages triggered by one or more events, or any combination thereof.

5. The apparatus of claim 1, wherein the one or more processors are configured to cause the UE to:
receive a metric type indication that indicates a communication scheme usable for communications with the plurality of TRPs, the communication scheme comprising a joint reception scheme, spatial division multiplexing scheme, a single frequency network scheme, a time division multiplexing scheme, or any combination thereof, wherein the one or more antenna ports are selected in accordance with the communication scheme.

6. The apparatus of claim 1, wherein the one or more processors are configured to cause the UE to:
receive a metric type indication that indicates an energy efficiency scheme usable for communications with the plurality of TRPs, wherein the energy efficiency scheme indicates one or more energy efficiency metrics, and wherein the one or more antenna ports are selected in accordance with the energy efficiency scheme.

7. The apparatus of claim 1, wherein the one or more processors are configured to cause the UE to:
receive, for each TRP of the plurality of TRPs, an indication of one or more parameters associated with computation of an uplink spectral efficiency associated with each TRP of the plurality of TRPs, wherein the evaluation is based at least in part on the one or more parameters for each TRP.

8. The apparatus of claim 7, wherein the one or more parameters comprise a quantization distortion indication, a covariance matrix for uplink noise and interference associated with a respective TRP, one or more calibration parameters, or any combination thereof.

9. The apparatus of claim 1, wherein the one or more processors are configured to cause the UE to:
transmit a message comprising a first indication of a quantity of ports selected for each combination of the one or more combinations, a second indication of one or more metric values associated with the one or more downlink reference signals in accordance with the evaluation of the one or more measurements, a third indication of a respective metric value associated with each combination of the one or more combinations, or any combination thereof.

10. The apparatus of claim 9, wherein the message further comprises a fourth indication of a quantity of ports selected for each combination of a threshold quantity of combinations and a respective metric value associated with each combination of the threshold quantity of combinations.

11. The apparatus of claim 1, wherein the one or more processors are configured to cause the UE to:
receive a size indication that indicates a respective quantity of sub-configurations within each combination of the one or more combinations.

12. The apparatus of claim 1, wherein, to communicate with the plurality of TRPs, the one or more processors are configured to cause the UE to:
communicate with each TRP of the plurality of TRPs via a respective set of one or more antenna ports of a plurality of antenna ports, each respective set of one or more antenna ports selected by the UE in accordance with the evaluation of the one or more measurements.

13. The apparatus of claim 1, wherein each CSI report configuration of the plurality of CSI report configurations is associated with a CSI resource configuration that indicates multiple downlink reference signal resources associated with each respective TRP of the plurality of TRPs.

14. The apparatus of claim 1, wherein the one or more antenna ports are selected based at least in part on a channel reciprocity associated with the one or more downlink reference signals.

15. The apparatus of claim 1, further comprising:
one or more antenna elements, wherein the one or more processors and the one or more antenna elements are configured to cause the UE to:
receive the one or more downlink reference signals in accordance with the plurality of CSI report configurations, wherein the evaluation of the one or more measurements is based at least in part on one or more respective measurements of the one or more downlink reference signals.

16. An apparatus for wireless communication at a network entity, comprising:
one or more memories; and
one or more processors coupled with the one or more memories and configured to cause the network entity to:
output one or more control messages that indicate a plurality of channel state information (CSI) report configurations, wherein each CSI report configuration of the plurality of CSI report configurations comprises one or more sub-configurations, wherein each CSI report configuration of the plurality of CSI report configurations is associated with a respective transmission and reception point (TRP) of a plurality of TRPs;
output an indication to perform an evaluation of one or more measurements associated with one or more downlink reference signals in accordance with one or more combinations of sub-configurations, wherein each combination of the one or more combinations includes a plurality of sub-configurations, and wherein each sub-configuration of each plurality of sub-configurations is from a respective CSI report configuration; and
obtain a report that indicates one or more antenna ports in accordance with the indication to perform the evaluation.

17. The apparatus of claim 16, wherein the one or more processors are configured to cause the network entity to:
output a metric type indication that indicates a communication scheme usable for communications with the plurality of TRPs, the communication scheme comprising a joint reception scheme, spatial division multiplexing scheme, a single frequency network scheme, a time division multiplexing scheme, or any combination thereof, wherein the one or more antenna ports are selected in accordance with the communication scheme.

18. The apparatus of claim 16, wherein the one or more processors are configured to cause the network entity to:
output a metric type indication that indicates an energy efficiency scheme usable for communications with the plurality of TRPs, wherein the energy efficiency scheme indicates one or more energy efficiency metrics, and wherein the one or more antenna ports are selected in accordance with the energy efficiency scheme.

19. The apparatus of claim 16, wherein the one or more processors are configured to cause the network entity to:
output an indication of one or more parameters associated with computation of an uplink spectral efficiency associated with each TRP of the plurality of TRPs.

20. A method for wireless communication at a user equipment (UE), comprising:
receiving one or more control messages that indicate a plurality of channel state information (CSI) report configurations, wherein each CSI report configuration comprises one or more sub-configurations, and wherein each CSI report configuration of the plurality of CSI report configurations is associated with a respective transmission and reception point (TRP) of a plurality of TRPs;
receiving an indication to perform an evaluation of one or more measurements associated with one or more downlink reference signals in accordance with one or more combinations of sub-configurations, wherein each combination of the one or more combinations includes a plurality of sub-configurations, and wherein each sub-configuration of each plurality of sub-configurations is from a respective CSI report configuration; and
communicating with the plurality of TRPs via one or more antenna ports selected by the UE, the one or more antenna ports selected in accordance with the evaluation of the one or more measurements.
